(19) United States
(12) Patent Application Publication
(10) Pub. No.: US 2019/0196449 A1
(43) Pub. Date: Jun. 27, 2019

(54) DETERMINING MANUFACTURABLE MODELS

(71) Applicants: Yunbo Zhang, West Lafayette, IN (US); Karthik Ramani, West Lafayette, IN (US)

(72) Inventors: Yunbo Zhang, West Lafayette, IN (US); Karthik Ramani, West Lafayette, IN (US)

(21) Appl. No.: 16/099,245

(22) PCT Filed: May 5, 2017
(86) PCT No.: PCT/US2017/031330

§ 371 Date: Nov. 6, 2018

Related U.S. Application Data
(60) Provisional application No. 62/332,916, filed on May 6, 2016.

(51) Int. Cl. G05B 19/4099; B33Y 50/00; B29C 64/386; G06F 17/50

(52) U.S. Cl. CPC G05B 19/4099; B33Y 50/00; G05B 2219/49023; G06F 17/5009; B29C 64/386

(57) ABSTRACT

Various examples provide systems, methods, and computer-readable media for determining manufacturing data based on three-dimensional models. The manufacturing data can include data of outlines of planar models, e.g., corresponding to partitions of the three-dimensional model. Various examples include operating a manufacturing device, e.g., a cutter or mill, to produce physical components based at least in part on the manufacturing data. Various examples include determining the manufacturing data for a partition corresponding to a hollow extrusion of a contour of that partition. Various examples provide user interfaces permitting users to modify parameters of the manufacturing data, e.g., contour shape or extrusion thickness. Various examples permit cutting sheet material into components that can be folded into three-dimensional shapes and assembled into a three-dimensional model.

### CROSS-REFERENCE TO RELATED APPLICATIONS

This application is a nonprovisional application of, and claims priority to and the benefit of, U.S. Provisional Patent Application Ser. No. 62/332,916, filed May 6, 2016, and entitled “Determining Manufacturable Models,” the entirety of which is incorporated herein by reference.

### BRIEF DESCRIPTION OF THE DRAWINGS

Objects, features, and advantages of various aspects will become more apparent when taken in conjunction with the following description and drawings wherein identical reference numerals have been used, where possible, to designate identical features that are common to the figures. The attached drawings are for purposes of illustration and are not necessarily to scale.

FIG. 1 depicts an example scenario, including a 3D model, a modified model, physical parts for assembly into a physical embodiment of the modified model, and the assembled modified model.

FIG. 2 depicts an example process of preparing components for assembly into a physical object.

FIG. 3 depicts example widgets and operations for determining cutting planes or extrusions.

FIG. 4 depicts example widgets and operations for determining manufacturable contours.

FIG. 5 depicts example widgets and operations for determining relative motion of components of an assembly.

FIG. 6 depicts example components and operations for assembling components that can rotate with respect to each other.

FIG. 7 depicts example operations for determining a conflict-free unfolding of faces of an extrusion of a polygon.

FIG. 8 depicts example manufacturing devices and example components prepared according to example techniques herein.

FIG. 9 depicts example 3D models and physical embodiments of those models constructed using unfolded extrusions according to some examples.

FIG. 10 depicts physical embodiments of a T-rex model.

FIG. 11 depicts example widgets and operations for manufacturing a customized item according to some examples.

FIG. 12 is a flowchart of example methods of receiving user input, determining manufacturing data, or operating a manufacturing device.

FIGS. 13-28 are graphical representations of screenshots of example user interfaces.

FIG. 29 is a graphical representation of a photograph of a person assembling a physical embodiment of a model according to a tested example.

FIG. 30 is a high-level diagram showing the components of a data-processing system.

### DETAILED DESCRIPTION

The terms “I,” “we,” “our,” “their,” “one” (in reference to an unspecified person), “user,” “designer,” “maker,” and the like throughout this description do not refer to any specific individual or group of individuals. Throughout this description, some aspects are described in terms that would ordinarily be implemented as software programs. Those skilled in the art will readily recognize that the equivalent of such software can also be constructed in hardware, firmware, or micro-code. The present description is directed in particular to algorithms and systems forming part of, or cooperating more directly with, systems and methods described herein. Aspects not specifically shown or described herein of such algorithms and systems, and hardware or software for producing and otherwise processing signals or data involved therewith, can be selected from systems, algorithms, components, and elements known in the art. Given the systems and methods as described herein, software not specifically shown, suggested, or described herein that is useful for implementation of any aspect is conventional and within the ordinary skill in the art. ILLUSTRATIVE PROCESSING

Current trends in democratization of fabrication make it possible for one to personalize manipulative designs through the choice of geometries, materials, and fabricate them on demand. A variety of rapid, early, but flexible prototyping techniques, such as 3D printing, laser cutting, and home milling machines, are gaining popularity among the DIY crowds. As a result, individuals now are able to fabricate artistic and personal objects without being technically trained to use sophisticated computational and production tools.

Origami has been contextualized into many design systems to create foldable 3D structures. The real beauty of folding lies in its elegant simplicity using 2D sheet of material to create complex 3D shapes and forms. During the last 40 years, why's, what's, and how's of different origami tessellations and structures have been geometrically and symbolically described by the underlying mathematical rules, such as flat foldability and folding any polygonal shape. With the marriage of computational geometry and origami, systematic design tools have also been developed recently.

Some prior schemes for foldable structures and crafts are limited by the following characteristics: 1) most developments have a typical goal of achieving automation of the design process to construct deterministic shapes and structures. However, in these systems, users are not allowed to participate and customize the desired shape to be folded, determine the parts to be articulated, and decide how the parts are joined. 2) Given any single model with articulated features, it is a daunting task using traditional mechanical design approaches to synthesize and prototype interconnected joints in order to make the model movable. 3) Conventional design and manufacturing tools are highly-procedural and require elaborate training and practice before they can be effectively utilized. Such limitations of these tools impede the integration of designing and making of complex shapes for an independent tinkerer.

Various aspects provide a novel customizable prototyping, modeling, or manufacturing framework, referred to herein without limitation as “CardBoardiZer.” Using CardBoardiZer, one can produce a foldable, articulable model based on an existing 3D model. We aim to democratize the design and fabrication together so that designers who lack specialized knowledge can quickly prototype. It is suitable for, among others, novices in the maker movement, K-12 crafting activities, hobbyists, and even college level use in prototyping and physical computing classes. The new standards for U.S. STEM education framed by the National Research Council have an explicit focus on engineering and design. Our methodology encourages the design, make, and play through creating, tinkering, using widely available materials, which is valuable for promoting user engagement. Various examples can be used by the DIY community where the versatile prototyping material, cardboard, and a low-cost crafting cutter are used for cutting and then folding is done by hand. Although various aspects are discussed with reference to cardboard as a material, this is not limiting. Examples herein can additionally or alternatively be applied with respect to other materials available in sheet form, e.g., sheet metal or solid craft foam sheets.

Various examples allow one to quickly and easily personalize desired designs, through the choice of geometries and articulations, to create foldable cardboard crafts and prototypes. Hence, the barrier to entry into 3D modeling and prototyping is lowered not only by directly repurposing the types of shapes, but indirectly by using cardboard itself as the material. The subsequent folding and assembling using their own hands become a source of pride and satisfaction.

Various examples permit a rapid cycle of prototyping at early conceptual design stages, including folding and die cutting.

Various examples provide a design platform that can provide a workflow for different stages of customization, such as shape segmentation and modification, resolution definition, and specification of motion joints.

Various examples provide a visual interface that can be integrated with the physical behaviors such as foldability, motion constraints, and articulation.

Various examples permit readily fabricating physical prototypes from, e.g., inexpensive, lightweight, and readily available materials that are widely used in the physical prototypes, such as cardboard.

CardBoardiZer is a new genre of cardboard based rapid prototyping system that can create new affordances for experimentation and expressiveness of designers. Various examples provide a new workflow using the customizable segmentation, shape approximation, articulation specification and unfolding design to allow rapid customization and prototyping. The geometric operations are made accessible for novice designers and use existing 3D sculptural models. Some previous schemes generate foldable patterns with a relatively small amount of folds, reducing the effort and time. However the shape approximation of such models is not satisfactory. On the other hand, complex unfolded mesh patterns created by some prior tools, and patterns created using optimized topological surgery techniques, approximate the input model well but demand a high effort and time to fold, making these methods accessible only to a few that have the expertise, manual dexterity and patience.

Various examples provide affordances for a new intermediate level foldable crafting form that provides manufacturable versions of existing 3D models. Example design platforms integrate customizable segmentation, contour extraction and approximation, geometric simplification, articulation specification and design of unfolding into a compact design environment to help one easily generate, or to directly provide, foldable patterns ready for cutting and folding. We retain the ease of foldability of the shape as a useful characteristic for the user, but at the same time serve the geometric shape approximation. The alternating curve and straight regions (ACSR) form not only retains the curvy shape in curved regions, but also simplifies the folding process for each of the partitions. Only a small number of straight regions have to be coupled for closing the shape. To automate ACSR, we have developed a new geometric simplification algorithm. By integrating straight portions, this algorithm also provides a basic level of structural integrity. Also by manipulating the ACSR resolution, designers can balance the shape approximation with the total time and folding effort.

Origami as an ancient art form was adopted in many design applications. People explored different origami structures for different purposes, such as foldable napkins, origami patterns for animals, soft plastic origami blocks, paper folding puzzles, portable stage assembly with origami set, and foldable wine tote. Nevertheless, these works are all specific designs and cannot be easily automated and generalized.

In computer graphics, researchers have studied different geometric processing and rendering techniques to unfold 3D meshes, e.g., to approximate input 3D meshes to 2D patches. Some prior schemes include a heuristic approach to unfold 3D triangular meshes without shape distortions. Variational shape approximation applied a mutual and repeated error-driven optimization strategy that provides polygonal plane proxies to best approximate a given 3D shape. Some prior schemes used a set of triangular strips to approximate an input 3D mesh, while others segmented the mesh into explicitly developable parts that can be cut and glued together. Similarly, some schemes have proposed an algorithm to approximate input 3D model using developable strip triangulations. Traditional mesh segmentation and parametrization techniques also provide the implicit mapping between 3D shape and 2D facets. However, all these methods result in a large number of planar segments that are impractical or difficult to join. In addition, physical construction and assembly constraints are rarely considered in these purely digital approximation techniques.

On the commercial side, many computational design tools have been developed for the user to import a 3D textured model and unfold it into flat sheets suitable for printing. In addition, some online supportive communities are bringing commercial paper crafting and shipping services directly to customers. In general, all these systems and methods try to focus on the automatic fabrication process from an original mesh model. In our work, we seek a middle ground to empower the DIY community to produce foldable and articulable shapes, e.g., for prototyping or other uses.

3D shape constructions using interlocked planar sections have been widely investigated for the ease of fabrication and assembly. Some schemes permit users to design their own models by sketching and assembling each planar slice one by one, while other schemes can automatically convert a 3D model into planar slices. These proposed optimization algorithms derive sets of physical construction constraints to be satisfied in order to guarantee a rigid, stable, and collision-free final construct. Nevertheless, the purpose of these methods is to generate a static and decorative object. In all these methods the resultant object has only one body with no joints that have motion and also they cannot house other components due to lack of interior spaces.

Other prior schemes provide interactive systems for designing animated mechanical characters by kinematic synthesis based on the output trajectories or configurations specified by users, or permit building linkage-based toys made of paper. Tubes, ball-socket joints, and cuboids are embedded into given sculptural 3D models for housing of functionalities and articulation in some schemes, and are fabricated by 3D printing processes. In contrast, various aspects herein enable the creation of inexpensive foldable cardboard patterns for the Maker-DIY community from a wide variety of existing sculptural models.

Cardboard, or carton board, is considered as the natural and recyclable material for constructing rapid prototypes and packaging consumer and food commodities. The typical structure includes two flat panels coupled with a corrugating medium and the fibrous material to provide higher tensile strength and surface stiffness than regular craft papers. The cardboard material not only reduces the weight of the box, but also lends itself to the ease of manufacture, such as die-cutting. As the personal fabrication movement continues to lower the barrier of entry-level manufacturing systems, more and more portable desktop-scale and low-cost craft cutters and 3D printers have gained significant hobbyist, academic, and industry interest. Some examples use cardboard as a material for constructing 3D models that are found or created by users. In some examples, we utilize the paper craft die-cutter to efficiently convert digital crease patterns determined as described herein into flat cardboard prototypes.

Various examples employ geometric processing algorithms described herein to permit users to customize, articulate, and fold a given model, e.g., a 3D model.

Various examples provide a building platform to allow the designer to 1) import a desired 3D shape, 2) customize articulated partitions into planar or volumetric foldable patterns, and 3) define rotational movements between partitions. The system unfolds the model into 2D crease-cut-slot patterns ready for cutting and folding. Complex geometric operations such as segmentation, contour generation and articulation specification, and shape control will be easily performed by simply drawing user-interface strokes on the model, adjusting a control widget, or using a slider bar for different resolutions. A geometric simplification algorithm is developed to leverage both the foldability and shape approximation of each model. Furthermore, compared to some prior schemes, some examples herein can provide significantly shorter time-to-prototype and ease of fabrication. Described herein are example use case scenarios. Some examples include a cloud based co-design platform powered by CardBoardiZer and intuitive user interfaces, e.g., to enable users to design and fabricate their own personal toys, e.g., dolls, action figures, or robotic toys.

Various aspects herein can be combined in an integrated environment or operated independently. The foregoing is not intended to identify key features or essential features of the subject matter of this disclosure. Various aspects describe subjects, devices, environmental apparatus, the environment itself, and configurations of objects, virtual and real.

Various examples include frameworks, processes, or methods aimed at enabling the expression and exploration of 3D shape designs enabled through natural interactions using non-instrumented tangible proxies. Below are described example systems, system components, processes involved in 3D shape exploration, and methods to achieve the steps involved in those processes.

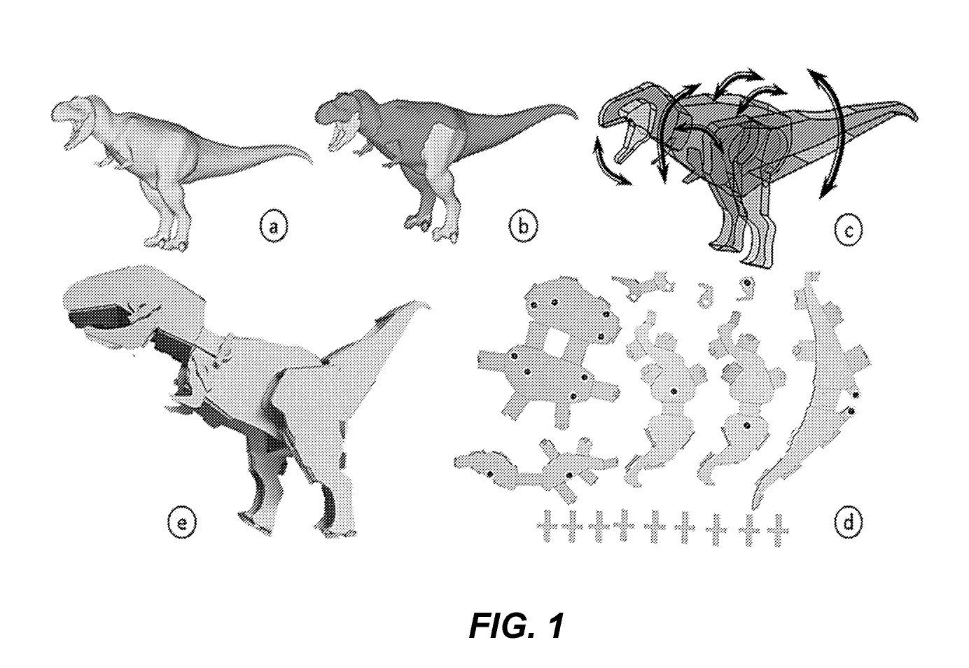

FIG. 1 shows a use case scenario using CardBoardiZer: Given a 3D mesh T-Rex model as shown at (a), CardBoardiZer allows the user to customize the segmentations at the locations where parts are desired to be articulated, as shown at (b), and to specify the corresponding rotational joint motions, as shown at (c). The crease-cut-slot patterns are then generated by the system, which can then operate a manufacturing device to produce the cut parts illustrated at (d). A user can then cut, fold and assemble a complete physical model, i.e., a physical embodiment of the data of the 3D model, shown at (e), e.g., using cardboard.

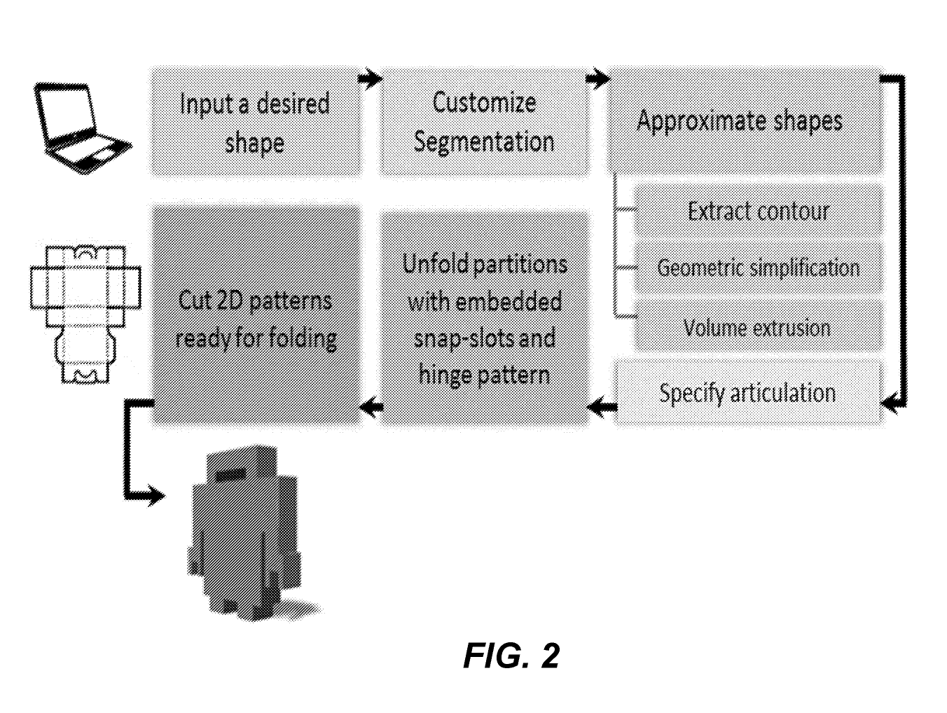

FIG. 2 shows an example building process of CardBoardiZer: given a 3D mesh model provided by user, the user customizes the partitions as desired, and enables each partition foldable using planar contour or extruded volumetric representations. The joint motion of articulated partitions is then specified and the system generates the crease-cut-slot patterns ready for die-cutting and folding.

CardBoadiZer produces customizable, articulated, and foldable prototypes directly from a digital 3D model. As shown in FIG. 2, an example computational design platform workflow is as follows: the designer (1) inputs a desired 3D mesh model, (2) customizes the segmented parts within the model to be articulated, (3) approximates the shape of each partition using a planar contour or an extruded volume, (4) augments the relative articulated movement between partitions, and then (5) develops the crease-cut-slot patterns ready to be die-cut and folded. The user is able to carry their creativity and intent towards the control of the number of articulated partitions, feature details, motion complexity, and the corresponding foldability.

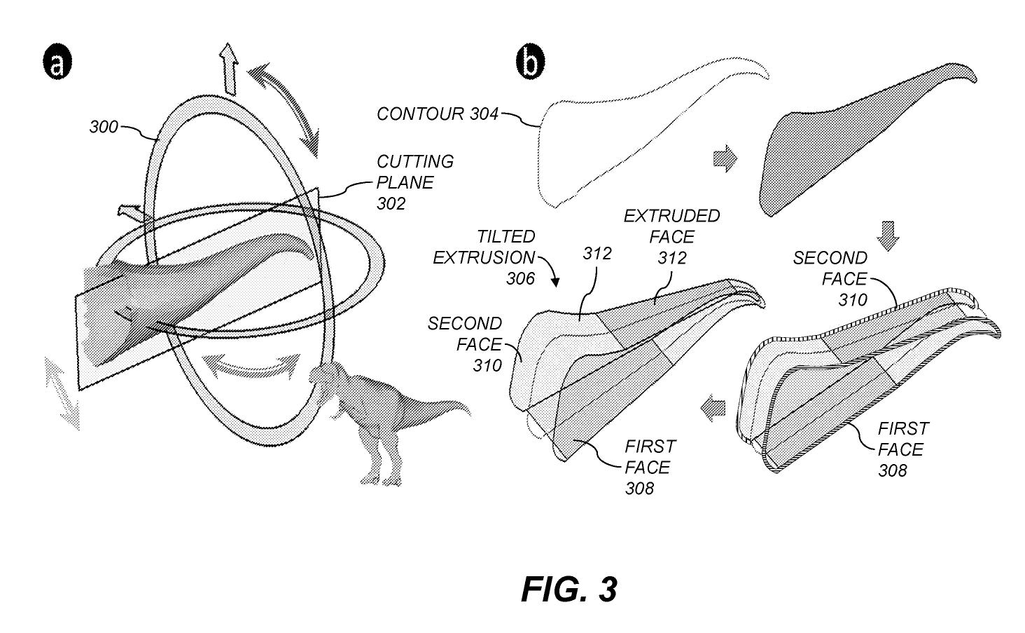

FIG. 3 shows graphical representations of example widgets 300 provided by a user interface as described herein, and related operations and models. Throughout the remainder of this document, a T-Rex model is used for clarity of illustration and explanation. However, examples herein are not limited to T-Rex models, and can be used for other models. At (a), is shown display of the representative contour of the tail partition generated by a widget-based interactive tool. The two illustrated circular widgets can receive user input to adjust the normal of a cutting plane 302. Throughout this disclosure, the term “cutting plane” can refer to an infinite plane or to a polygonal segment of a cutting plane. For example, in FIGS. 3 and 16-19, cutting plane 302 is a planar rectangle, not an infinite mathematical plane. In some examples, the widget 300 can permit adjusting the size, orientation, or location of the cutting plane.

The portion of the 3D model in the cutting plane 302 defines a contour 304. The cutting plane 302 can be translated as well. At (b), once the contour 304 is selected and closed, an extrusion operation is used to generate volumetric models. The “tilting” operation that produced the “tilted extrusion” 306 shown at the lower center of FIG. 3 can permit generating a model with non-uniform thickness, here, the T-Rex's tail, which narrows towards the end of the tail.

Throughout this document, “extrusion” refers to hollow extrusion, in which two faces are connected with new faces to provide a desired thickness. Examples are discussed below. However, techniques described herein can also be used to generate shapes of solid extrusions to be produced by techniques other than cutting out of planar models. E.g., operations of FIGS. 2-4 and 13-27 can be used to determine shapes, e.g., to be milled as solid extrusions.

Contours are a basic representation of object shape since a contour contains explicit and dominant characteristics for determining an object's shape. As seen in FIG. 3, the widget at (a) is a planar section extraction tool in our platform to cut each partition with a plane and obtain the resultant cross-sectional contour. To generate an initial cutting plane, the system applies the principal component analysis (PCA) so that the plane is created by taking the principal axis with the smallest eigenvalue as the normal and passing through the geometric center. The widget can then be initialized to the determined initial plane. The widget-based tool can be used, e.g., by a user, to manipulate the cutting plane until it represents the shape as desired. The tool includes at least one of (or, in some examples, consists of) two circular widgets (e.g., orthogonal to each other) to rotate the plane and a motion widget to translate the plane (e.g., along any particular axis or axes). Once the contour is selected, the user can choose to extrude the contour section along the normal vector of the cutting plane to create a prismatic model, or to retain the original planar shape. CardBoardiZer also allows for symmetrically tilting the prism surface with a non-uniform thickness, e.g., extruding normal to the cutting plane by an amount that varies across the cutting plane. A sketch completion tool can receive user input indicating how an open contour should be closed. Therefore a generated contour is not necessarily a closed loop.

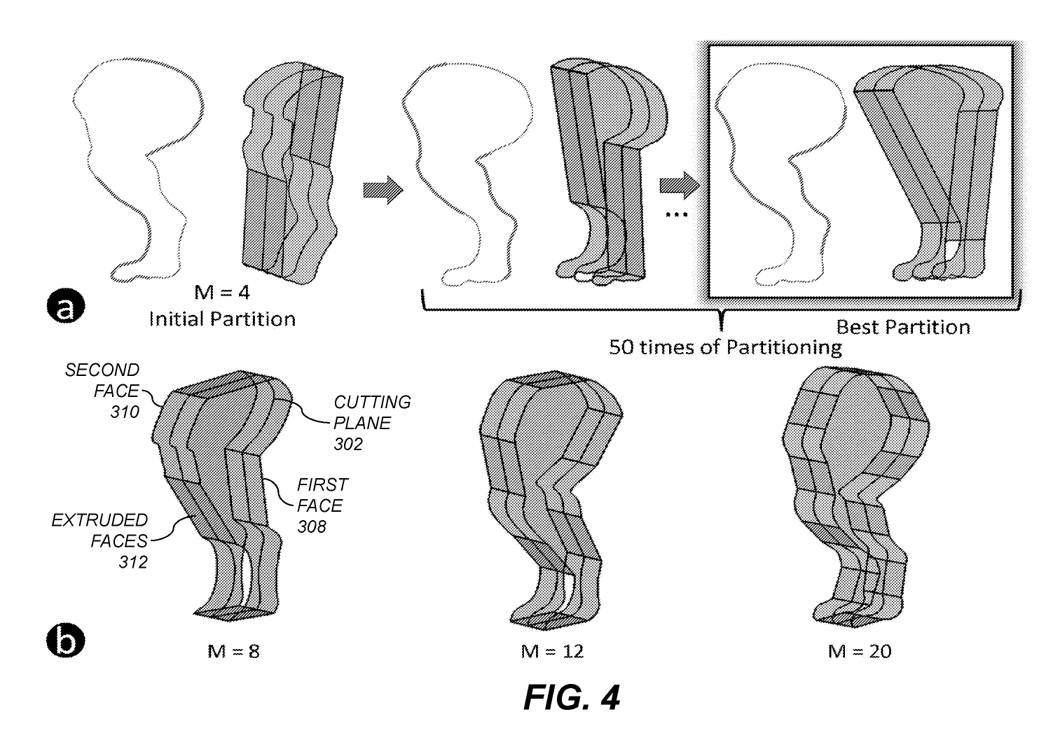

In some examples, an extrusion, e.g., a tilted extrusion 306 as shown (“tilted”) or a non-tilted extrusion such as shown in FIG. 4, includes a first face 308 (shown front, the T-rex's left) and a second face 310 (shown rear, the T-rex's right) substantially parallel to the cutting plane 302. Faces “substantially parallel to the cutting plane” can, e.g., have normals 10°, 30°, or <45° from the normal to the cutting plane, in various examples. A plurality of extruded faces 312 (e.g., the top and bottom of the tail from the T-rex's point of view; for clarity, not all are labeled) extend substantially normal to the cutting plane 302 and, e.g., connect the first face 308 with the second face 310. Each extruded face 312 can be associated with a segment of the contour 304, e.g., can be the extrusion of the respective segment along the normal to the cutting plane 302. Segments are discussed below, e.g., with reference to FIG. 4, operation #3.

FIG. 4 shows examples of geometric simplification. When considering unfolding, volumetric models that are extruded from highly curvy contours usually result in a high number of folding lines and make the fabrication and assembly difficult or impractical. Therefore, it is useful to geometrically simplify the contours before extrusion. In various examples, simplification can: 1) generate as few folding edges as possible to alleviate the construction burden, or (2) approximate the shape of original curve as much as possible. Existing simplification algorithms give a rough shape approximation and a limited number of retained edges. In some prior schemes, the shape is isotropically coarsened with straight and curved regions. Various examples provide a geometric simplification algorithm that simultaneously leverages the foldability and shape approximation. Examples herein provide geometric simplification for leveraging foldability and shape approximation.

Various examples of the algorithm operate to classify the contour curve, e.g., the whole contour curve, into alternating curve and straight regions (ACSRs), as shown in FIG. 4. The straight regions are illustrated in a darker shade than the curve regions. Each straight region is approximated by a single line segment and will be extended later with connecting “side walls” to close up the volume, while the curvy regions are left open to preserve the curvy features of the contour. To ensure the folded model to be structurally integral, as a heuristic, various examples evenly distribute the straight and curved regions along the whole contour length.

To leverage the foldability and shape approximation, various examples of a simplification algorithm herein operate as follows:

1. Initial region classification Points on each contour (e.g., control points, sample points, or mesh points; not necessarily each and every one of the infinity of mathematical points on any curve) are parameterized using an arc length parameterization. In some examples, every point is parameterized by arc length. Based on this parameterization, by inserting M evenly distributed (along the arc length) anchor points, the whole closed contour is divided into M regions from R₁ to R_{M}. Therefore, M can be referred to as a “region count.” The regions are specified into straight and curved regions alternatively. If Rᵢ is assigned as straight region, Rᵢ₊₁ (i, i+1∈[1, M]) will be the curvy regions, and vice versa. This initial classification provides that the distribution and length of each straight and curved regions are substantially the same as those of the other regions.

2. Classification search Based on the results of initial region classification, a search algorithm is applied to determine a region classification that preserves the original shape best, where “best” is defined with respect to an error evaluation metric. An example error evaluation metric is defined as follows:

$$Score = \frac{{\sum }_{j ∈ [ 0 , M ]} \overline{chordal} ( {R}_{j} )}{{\sum }_{k ∈ [ 0 , M ]} \overline{chordal} ( {R}_{k} )} \qquad ( 1 )$$

where Rⱼ is a curved region and Rₖ is a straight region. c̅h̅o̅r̅d̅a̅l̅( . . . ) measures the average chordal length error of each region.

The classification search algorithm is designed to find out a classification with, e.g., a mathematically maximum score, e.g., as evaluated by Eq. (1). In other examples, a different error evaluation metric can be used, and a classification with a mathematically minimum score can be found. In some examples, the classification search includes moving the starting point of the contour segmentation by successive small steps δ along the contour. This can permit repeatedly parameterizing the same contour with different parameters, e.g., a different starting point δ. For each parameter set, the score (e.g., Eq. (1)) is evaluated. The best region classification is then selected as the parameter set having the mathematically highest (or lowest, as appropriate) score. In some examples, the searching stops when the rotation reaches 2π/M degrees due to the rotational symmetry of the region classification. In some examples, the rotation step angle δ is set to 0.04π/M for balancing the classification quality and speed.

The top half of FIG. 4, at (a), shows an initial partition with δ=0. As indicated, 50 different values of δ were evaluated using Eq. (1). Two examples are shown. In the upper right is shown the contour corresponding to the value of δ having the highest score.

3. Contour simplification. After a best region classification is selected, we perform the contour simplification by simply linking the starting and ending points of each straight regions. This permits manufacturing the model without a requirement that the fabrication equipment be able to make curved cuts. In some examples, contour simplification is not performed. In some examples, the volumetric model will only have M values less than 20, reducing the number of folds and cuts while preserving features of the shape of the model.

By selecting a different number for M, different levels of detail of the simplified models can be obtained. Some examples include various values of M, e.g., the integer powers of 2 up to 16, thereby three levels of details of the simplified models. In some examples, a pair of snap-slot patterns is added along each straight region to enclose the volumetric partitions.

Still referring to FIG. 4, at (a), when setting M to 4, our simplification generates a region partition with best score according to Eq.1 in the right upper corner. At (b) are shown various examples in which, by increasing M to 8, 12, and 20, the simplification results with improved shape approximation are obtained. In some examples, the classification search is performed separately for each value of M to find a respective value of δ. In some examples, the same value of δ is used for multiple values of M.

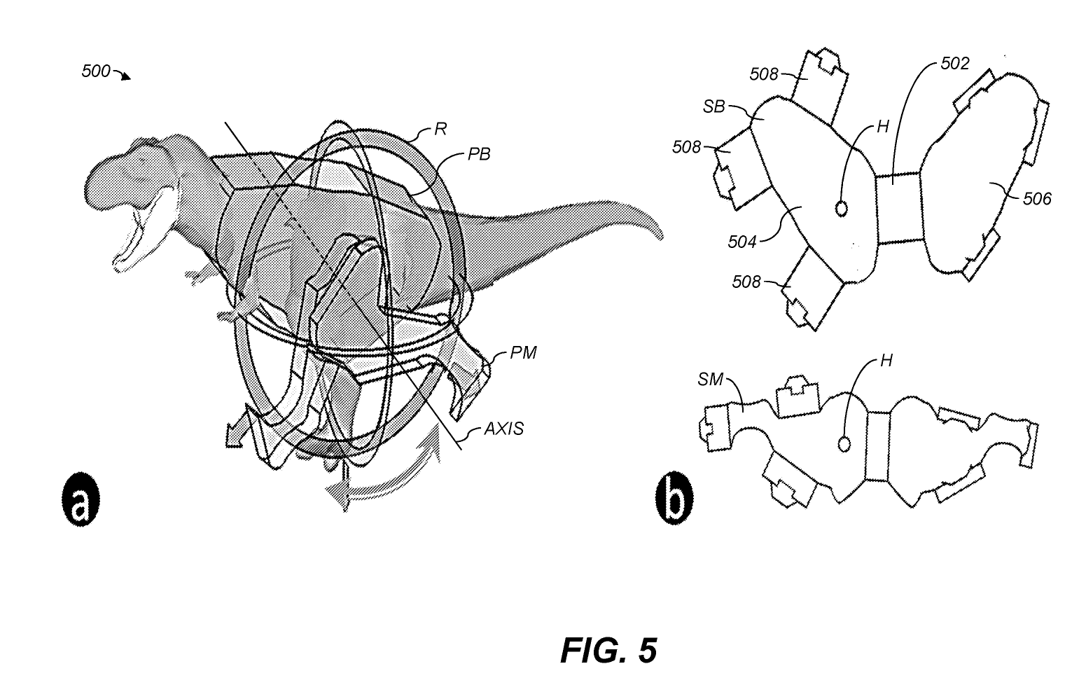

FIG. 5 shows articulation specification and motion hinge synthesis examples 500. At (a) is shown a relative rotation specified using our widget based tool by selecting P_{b}, Pₘ and rotation axis on widget R. At (b) is shown an example in which the pre-synthesized motion hinge patterns are automatically added onto unfolded patterns.

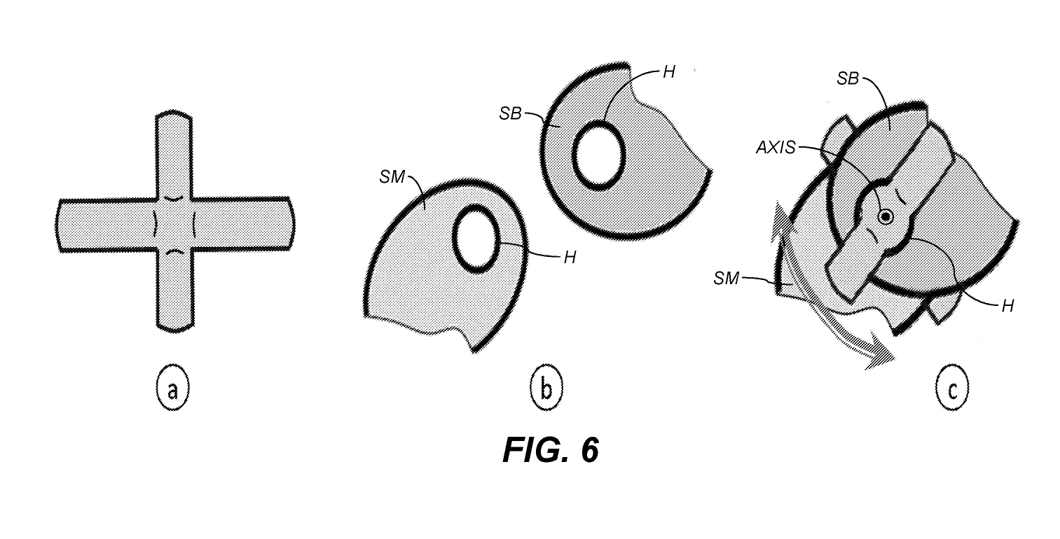

Setting up arbitrary axes or pivots using some prior mechanical approaches can be tedious and time-consuming. However, it is often the case that the desired manipulation constraint of an object exists in the candidate constraints of another scene object. Our system supports a simple interaction to let users to specify the relative motion between two parts. First, the user interactively specifies a partition P_{b} that serves as the fixed base, and the moving part Pₘ (e.g., a leg) that rotates with respect to P_{b} (e.g., a torso; see FIG. 5, at (a)). The rotation control widget R enables the user to specify which axis they like Pₘ to rotate about (shown in FIG. 5, at (a)). The mating surface S_{b} on P_{b} and Sₘ on Pₘ can be determined by finding the closest surfaces on two parts. To ensure the relative motion, our system automatically adjusts the orientation of Pₘ such that two mating surfaces S_{b} and Sₘ are coplanar. In some examples, the system provides visual feedback for collision detection during the relative motion between two parts. Once the motion is defined, we assemble each pair of articulated parts P_{b} and Pₘ with a synthesized modular and easy-to-assemble motion hinge kit, e.g., shown in FIG. 6. FIG. 5, at (b), shows an example of S_{b} and Sₘ. The holes H in S_{b} and Sₘ will receive the fastener (motion hinge kit) of FIG. 6. The holes can be examples of joint mating features, i.e., features of a model designed to permit mating between manufactured components.

The examples of FIGS. 5 and 6 show axial rotational motion, i.e., rotation around an axis. When the corresponding physical model is assembled, the axis of rotation is substantially normal to the holes H, and is substantially concentric with the holes H. Examples of such an assembly are shown in FIG. 5 at (a) and in FIG. 6 at (c) (labeled “AXIS”).

Referring to FIG. 5 and also to FIG. 3, in part B (the torso), and likewise in part M, the leg (labels omitted for brevity), upon unfolding, a connecting face 502 can connect the unfolded first face 504 with the unfolded second face 506. The remaining extruded faces 508 can be connected to at most one of the first face 504 and the second face 506.

FIG. 6 shows, at (a), a motion hinge fastener in the form of a cross-shaped piece, e.g., a strip of material cut in a cross shape. The strip can be used for connecting surfaces of adjacent partitions, shown at (b), with revolute joint motion. At (c) is shown the complete assembly.

Each motion-hinge kit includes a cross-shaped 2D strip and two circular holes on the patterns of adjacent partitions to be articulated, shown in FIG. 6. In order to generate a revolute motion between two partitions, the user assembling a physical model can overlap the two patterns together where the holes are aligned to each other, bend the two opposite tips of the stripe towards the middle, thread them into holes, and then release the tips on the other side. The strip then retains the holes in position with the axis of rotation (“AXIS”) passing substantially through the centers of the holes, permitting the parts SB and SM to rotate with respect to each other around the axis of rotation (“AXIS”).

Referring back to FIG. 5, at (a), in the illustrated example, widget R permits the user to define (e.g., receives data of) an axis of rotation (“AXIS”). This is an example of axial rotational motion between parts PB and PM, i.e., rotation substantially around an axis. Additionally or alternatively, widget R can permit the user to define translational constraints, e.g., motion along an axis, possibly constrained within certain limits. Additionally or alternatively, widget R can permit the user to define spherical rotational constraints, i.e., rotation substantially around a point with more than one degree of freedom (e.g., three rotational degrees of freedom, as in a ball joint). In some examples, widget R or other elements of a user interface (UI) such as UI 1300 can permit the user to select a type of motion to be determined, and then to provide parameters of that motion (e.g., location or orientation of a rotation or translation axis, or location of a rotation point). In some examples, the motion relationship can include at least one of an axial-rotational relationship, e.g., a rotational relationship about an axis; a translational relationship, e.g., along an axis; or a spherical-rotational relationship, e.g., a rotational relationship about a point.

In some examples, systems as described herein can determine the modified three-dimensional model (block 1208) according to motion constraints and connectivity between adjacent parts specified by or determined based on user inputs. The example of FIGS. 5 and 6 shows adding holes to permit axial rotation, for example. Other examples can include adding elongated slots to permit translational motion. In some examples, pairs or sets of parallel elongated slots can be added to permit translational motion while constraining rotational motion. In some examples, holes or other receptacles (e.g., sockets), or protrusions (e.g., knobs or balls) can be added to permit spherical rotational motion. All of these can be examples of joint mating features. Two partitions of a 3D model can be connected by none, one, or more than one joint mating feature. For example, a point, a slot, and a plane can be used to provide an approximation of kinematic mounting.

In some examples, the modified three-dimensional model can include data of connectors between two adjacent parts, e.g., the cross-shaped strips shown in FIG. 6 at (a) and (c), and also in FIG. 1 at (d). The shape of the connector can be determined based at least in part on the nature or parameters of a motion constraint specified by the user using a widget. For example, slots, ball joints, or holes can correspond with respective, different types of connectors.

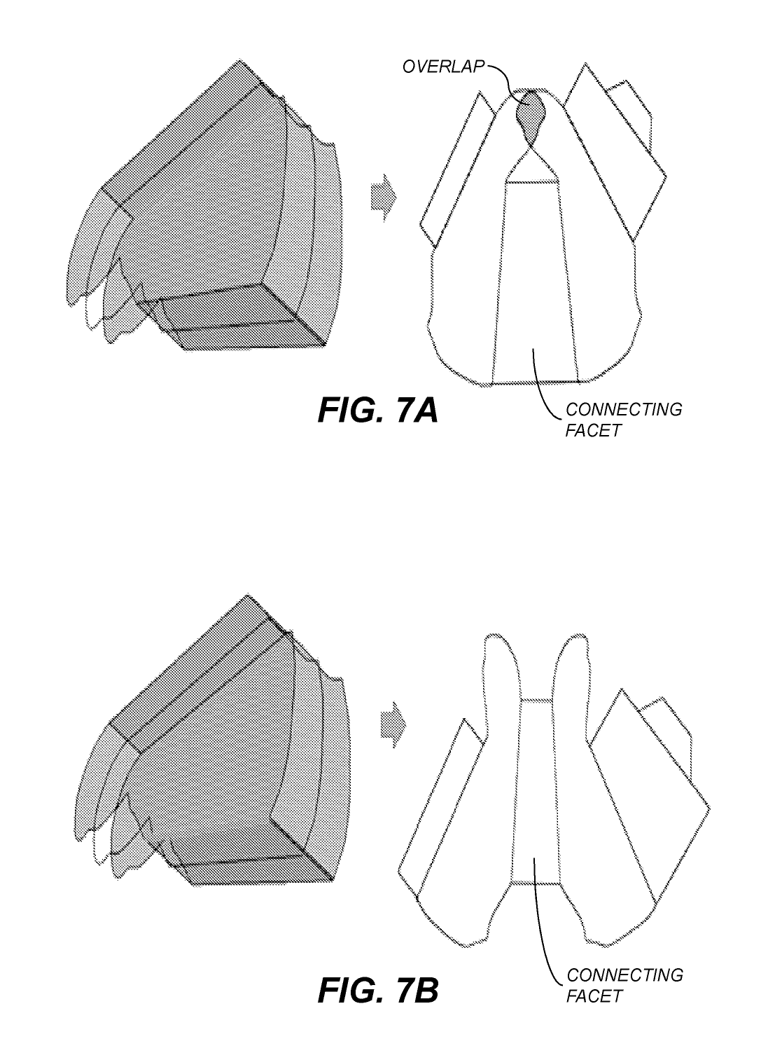

FIGS. 7A and 7B show examples of the design of unfolding of the extruded simplified contours determine as discussed herein with reference to FIG. 4. By selecting different straight line and curvy regions, an overlapping issue occurs in FIG. 7A, but not in FIG. 7B.

In various examples, the system automatically (e.g., under processor control) unfolds each extruded volumetric shape into a 2D pattern including motion hinges (e.g., holes H, FIG. 5) and snap-slot patterns. In some examples: 1) to ease the effort of assembly, the 2D pattern for each individual partition can preferably be a single connected patch, though this is not required, or 2) the pattern can be self-overlap-free so that all facets are cuttable. An example unfolding algorithm applies to one extrusion at a time, e.g., to the torso, the tail, the left leg, and the right leg individually. The example algorithm separates all the ACSRs on the contour, leaving one pair of straight regions for connecting facets. During unfolding, since the extruded volume is a polyhedron, an unfolding can be determined. However, the selection of unseparated straight regions cannot be arbitrary because the self-overlapping of facets might occur (see FIG. 7A, in which two pieces overlap when a first choice of connecting facet is made). We thereby develop a separation algorithm to provide a self-overlap-free unfolding result (see FIG. 7B, in which a second, different choice of connecting facet was made). The algorithm includes the following two steps, in some examples.

1. Edge sorting. All pairs of straight regions are sorted inside a queue W in a descending order of the edge length (i.e., longest first, although other sort orders or partial sort orders can be used in various examples).

2. Edge separation & unfolding. One pair of straight regions is pulled from the front of W. That pair is labeled as unseparated while other pairs (e.g., all other pairs) are labeled as separated. Existence of self-overlappings are checked after unfolding.

Step 2 is repeated until W is empty or an unfolding without self-overlapping is found. In the scenario where self-overlapping areas cannot be avoided, the algorithm assigns all straight regions as separated and thus the 2D pattern is separated into two pieces. The pieces can be assembled, e.g., by gluing together after cutting.

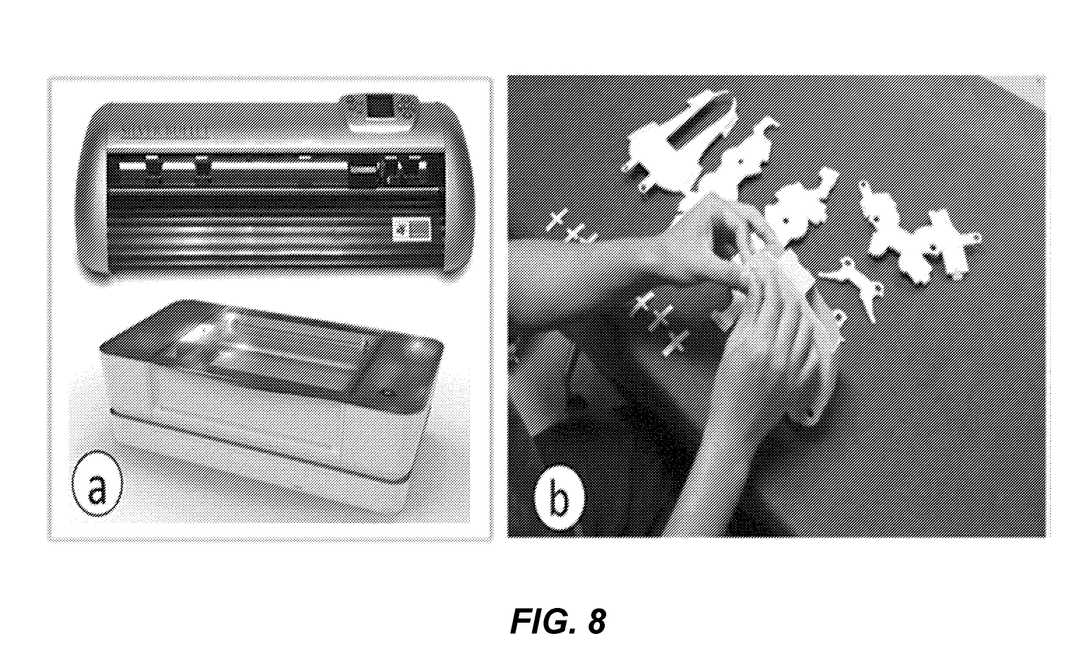

FIG. 8 shows examples of prototyping. At (a) is shown a 24″ SILVER BULLET Die cutter (top) and a desktop laser cutter GLOWFORGE (bottom). At (b) are shown cut 2D T-Rex patterns in the process of being folded and assembled.

A test was performed using commercially available cardboards as the building materials as they are cheap and easy to access. With the development of desktop die cutters (e.g., the SILVER BULLET or GLOWFORGE shown in FIG. 8 at (a)), the 2D cardboard patterns can be easily obtained and folded, e.g., manually (e.g., FIG. 8 at (b)).

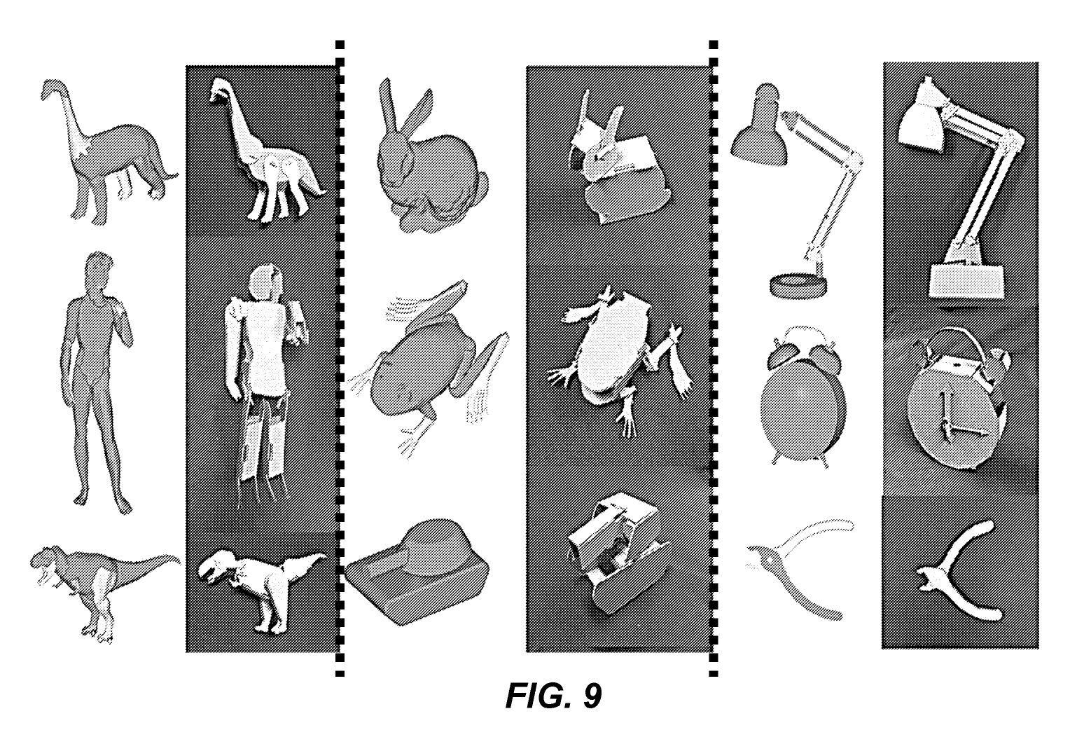

FIG. 9 shows example results generated by CardBoardiZer in a tested configuration using examples described herein. Columns are separated by heavy stippled lines. Each column is divided into a left half (light background), showing a graphical representation of a 3D model, and a right half (dark background), showing a graphical representation of a photograph of a cardboard rendition (physical embodiment) of that 3D model assembled from flat pieces cut out in shapes determined based on the 3D model using techniques described herein. First column from top down: Apatosaurus, Michelangelo's David, and T-Rex; second column from top down: Stanford bunny, tree frog, and tank; third column from top down: Desk lamp, clock and pair of pliers.

An example framework herein allows different articulated features of the model to be quickly customized, folded and assembled using cardboard material. FIG. 9 shows tested segmentation and prototype-construction results using 9 demonstrated examples, including 6 sculptural models (T-Rex, Apatosaurus, Michelangelo's David, Stanford bunny, tree frog and tank) and 3 real life objects (desk lamp, clock and plier).

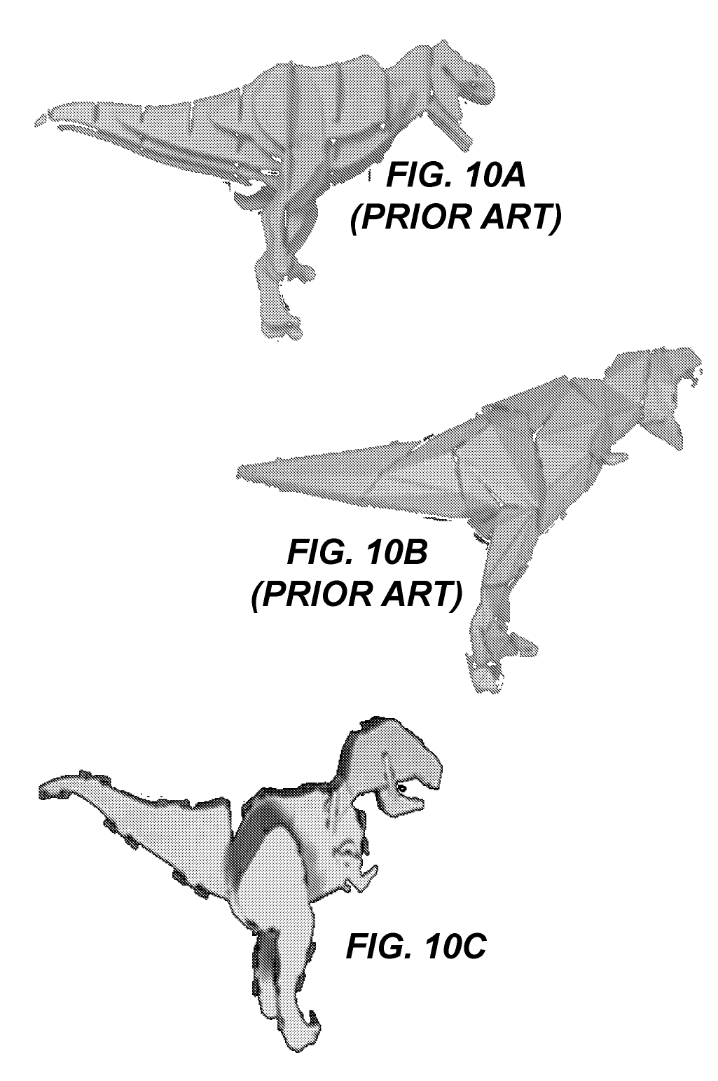

FIGS. 10A-10C show, respectively, graphical representations of photographs of three T-Rex physical models that were fabricated during a test. FIGS. 10A and 10B show comparative examples for a first prior scheme and a second prior scheme. For the test, in generating the physical models of all three of FIGS. 10A-10C, the T-Rex model was selected for all three physical models with identical scales (47 cm×19 cm×9 cm) and comparable resolutions.

FIG. 10A shows an example of a prior scheme using interlocked planar sections to approximate the shape using successive orthogonal cross-sections. This scheme permits the user to manipulate the total number and orientation of the planar sections, which are connected with slots. During the test, the tested scheme generated multiple slots along the concave shape regions, which made it difficult to assemble. Overall, the interlocked slices method as tested takes 6 mins to design the pattern, 18 mins to die cut the planar sections, and 38 mins to complete the assembly.

FIG. 10B shows an example of a prior scheme using folded panels. This scheme creates foldable patterns of a model by unfolding its 3D meshes into multiple patches and stripes. It is designed to approximate the shape by generating 2D folding patterns with a high number of folds (e.g., 198 folds for the tested T-Rex). However, it demands a very high effort and time to fold, assemble, as well as manual dexterity and patience. For example the T-Rex, as tested, required in total 5 mins to design the pattern, 23 mins to die cut the patches, and 3 hours and 32 mins to complete the whole assembly.

FIG. 10C shows an example of CardBoardiZer according to some examples herein. CardBoardiZer is designed to abstract the 3D shapes and approximate the individual bodies using a simple extruded cross-section. Compared to folded panels, CardBoardiZer reduces both the number of folds and time to fold. It also generates articulated features for the model that cannot be achieved using interlocked slices. Overall, as tested, CardBoardiZer required 5 mins to design the pattern, 8 mins to die cut, and only 7 mins to fold up the physical model. This is a significant improvement in the die cutting, assembly, and folding time compared to the tested prior schemes.

FIG. 10A depicts a fabricated T-Rex model produced according to a first prior scheme using interlocked slices. During the test, 6 minutes were required for designing the pattern, 18 mins for die cutting and 38 mins for assembly (in total 1 hr).

FIG. 10B depicts a fabricated T-Rex model produced according to a second, different prior scheme using folded panels. During the test, 5 mins were required for designing the pattern, 23 mins for die cutting, and 3 hrs and 32 mins for assembly (in total 4 hrs).

FIG. 100 depicts a fabricated T-Rex model produced using CardBoardiZer according to some examples herein. During the test, 5 mins were required for designing the pattern, 8 mins for die cutting and 7 mins for assembly (in total 20 mins).

In particular the dexterity and patience to fold or assemble according to prior schemes (e.g., FIGS. 10A and 10B) can be high so that many novices may not attempt crossing this barrier to entry. In addition, in some prior schemes, the users need to keep track of a large number of individual parts and their location and sequence to be assembled.

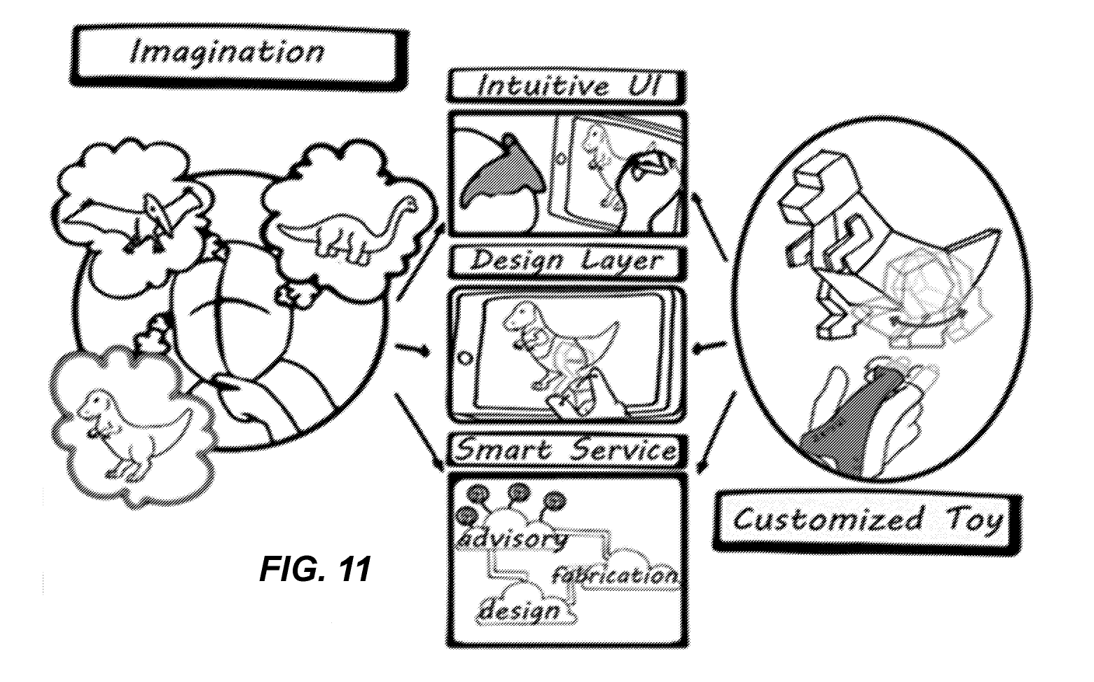

FIG. 11 shows an example use case permitting, e.g., design and fabrication of low-cost personal robots. Various examples include a platform, e.g., hosted on cloud servers, which allows users to create a customized toy using an intuitive interface powered by augmented-reality (AR) technology and CardBoardiZer. Some examples provide a cloud based co-design platform for (e.g.) personal robotic toys creation, based on CardBoardiZer and human-computer interaction (HCl) technologies. This platform includes at least one of the following three features, in any combination: (1) gesture and natural user interface (NUI) driven design interface, (2) geometric processing algorithms powered by CardBoardiZer (e.g., cloud-based), and (3) the fabrication of primitives for robotics with laser cutting and 3D printing devices or services. The co-design platform smart software or service using NUI based technologies can permit any person to become a designer and maker. It breaks the barriers of traditional computer-aided and WIMP driven metaphors. Powered by, e.g., cloud technologies, the smart geometric processing tools in CardBoardiZer can be accessed by more people in the co-design platform. Some examples permit everyday sculptural 3D models to be easily customized, articulated, actuated, and folded. An example design tool for generating physical foldable laser-cut models (FLCM) from existing 3D models itself can be embodied as a co-design service. Incorporated with a personal robotics toolkit, e.g., the ZIRO toolkit, in some examples, the generated articulated foldable objects can be easily converted into a low cost personalized robotic toys. In some examples not using robotics, the assembled physical models can be personalized toys or other personalized items, e.g., single-piece or articulable.

References herein to “displaying a three-dimensional model” and similar language can include displaying a two-dimensional projection of a three-dimensional model on a two-dimensional display device such as a computer monitor, to displaying the three-dimensional model on a volumetric display, or to displaying respective two-dimensional projections associated with the two eyes of a stereoscopic display. User-operable input devices, as described herein, can include, e.g., mice, trackballs, 6DOF manipulators, keyboards, head-trackers, eye-trackers, depth cameras (e.g., a MICROSOFT KINECT or other depth cameras), infrared-camera or other reference-light-sensitive trackers such as a NINTENDO WII remote or a light gun, accelerometers, or smartphones.

As discussed above with reference to FIGS. 1-11, various examples herein provide determination of shape data of extruded shapes. Various examples herein provide manufacturing data, e.g., including planar models. Various examples include providing planar models by applying unfolding algorithms to extruded shapes. Various examples herein provide manufacturing of extruded shapes in the form of cut sheets that can then be folded to provide physical realizations of the extruded shapes. The extruded shapes can then be combined, e.g., at joint mating features as described herein, to provide a physical model that embodies the extruded shapes.

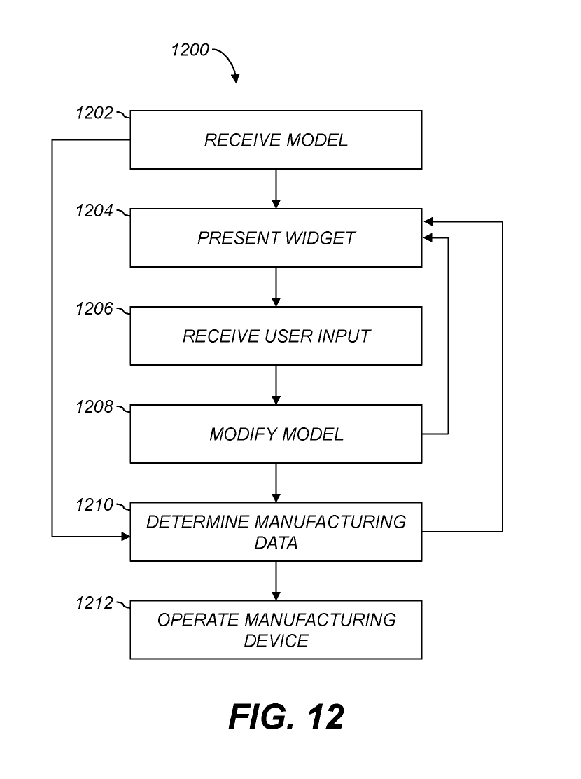

FIG. 12 shows a flowchart illustrating example processes 1200 for receiving user input, determining manufacturing data, or operating a manufacturing device. The steps can be performed in any order except when otherwise specified, or when data from an earlier step is used in a later step. In at least one example, processing begins with step 1202. For clarity of explanation, reference is herein made to various components shown in the figures that can carry out or participate in the steps of the example method. It should be noted, however, that other components can be used; that is, example method(s) shown in FIG. 12 are not limited to being carried out by the identified components.

In some examples, at block 1202, a model is received. The model can be a 3-D model, e.g., in BLENDER or AUTOCAD formats. Block 1202 can include scanning an object or combination of objects using a 3-D scanner, receiving a predefined model, or combining one or more existing models (e.g., made using a computer or scanned from physical objects). Block 1202 can include automatically extruding a 2-D model, e.g., an outline, to determine a 3-D model.

In some examples, the model is or includes a three-dimensional (3-D or 3D) model. The 3D model can include data of a plurality of polygons or other sub-shapes. For example, the model can include data indicating the vertices of polygons and associations between those vertices to form polygons, e.g., triangles, quads, or other polygons. The data can indicate multiple polygons in the form of data of triangle strips or fans, quad strips, or other polygons sharing one or more vertices with each other. The model can also include adjacency information associating individual ones of those polygons or other sub-shapes with each other. For example, the model can include information that a first edge of a first polygon is shared with a second edge of a second polygon, or that two polygons have a particular adjacency or spatial relationship. In some examples, the model can include data indicating locations of a plurality of vertices, and a plurality of vertex sets indicating polygons or groups of polygons defined by specific interconnections of ones of the vertices. Such a model is an example of the class commonly referred to as a “mesh.” In some examples, the 3D model can include primitives such as polygons or non-polygons, e.g., circles, cylinders, solids, or raytraced or other algorithmically-defined primitives (e.g., mathematical spheres, as compared to tesselated spheres).

In some examples, at block 1204, a widget is presented in a user interface. The widget can permit a user to modify the 3D model to provide a modified 3D model, e.g., a manufacturable 3D model that can be physically embodied via cutting and folding operations. Examples of widgets are discussed herein with reference to at least FIG. 1 (at (c)), 3, 4, 5, 11, 13-25, 28, or 30.

In some examples, at block 1206, user input is received. For example, data of user interactions with the widget can be received. Example user interactions are discussed herein, e.g., with reference to the figures listed in the preceding paragraph.

In some examples, at block 1208, the model can be modified (or a new model be determined based on the model, and likewise throughout this discussion) based at least in part on the received user input. For example, the user input can be used to determine cutting planes, extrusion widths, joint configurations, or other properties of a model. The 3D model can be modified to exhibit the corresponding properties. For example, FIG. 1 at (a)-(c) shows examples of an input model (at (a)), the model modified by division into segments (at (b)), and the model decomposed into manufacturable extruded parts (at (c)). Examples of modifying the model are described herein with reference to FIGS. 2-4.

In some examples, at block 1210, manufacturing data, e.g., planar manufacturing data such as planar model(s), can be determined for the modified model or a portion thereof. Note that planar manufacturing data does not constrain the thickness of the parts manufactured for assembly into a physical model. Various thicknesses of material can be cut based on the same planar manufacturing data.

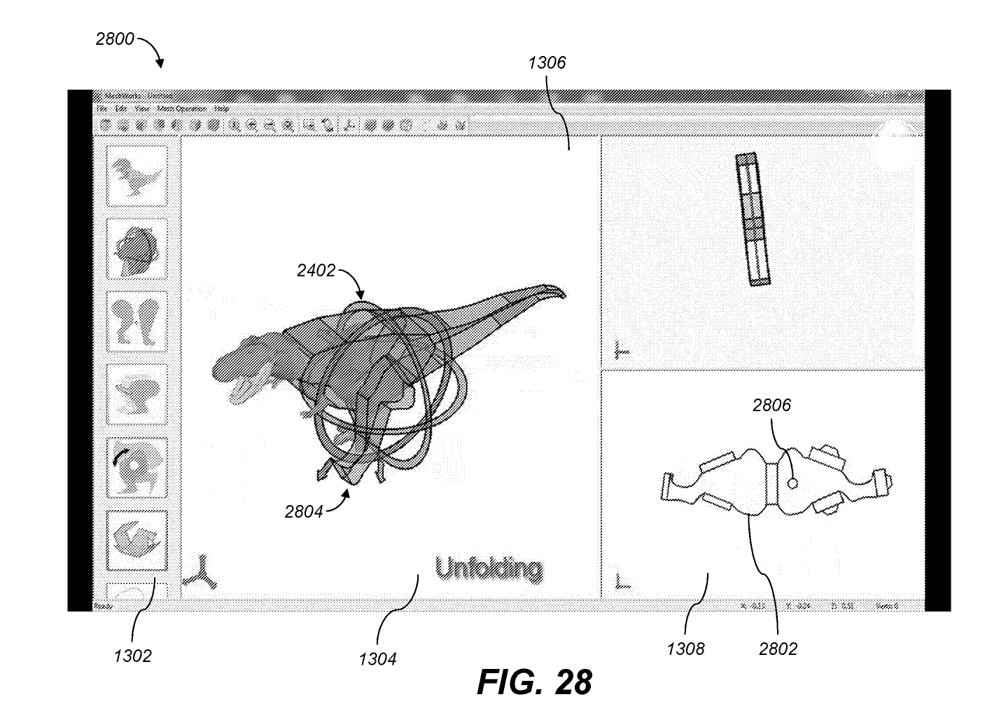

For example, block 1210 can include unfolding one or more parts of the modified model to respective outlines, such as in FIG. 5 at (b) or in area 1308 shown in FIG. 28. In some examples, block 1210 can include exporting SVG, PDF, Al, SCUT, DWG, DXF, IGES, or other vector formats. For example, the outlines of the unfolded parts can be exported as separate vector files, separate layers of a vector file, or spaced apart laterally within a vector file or at least one layer of a vector file. Unfolding is discussed above with reference to, e.g., FIG. 5. In some examples, unfolding can result in one, two, or more planar model(s) for respective component(s) capable of being joined together, once fabricated, to form a physical object representing or associated with the modified model or portion thereof. In some examples, the component(s) can be folded, then joined together in their folded states, or can be flat, and joined together in a non-folded state, or both. For example, FIG. 1, at (d), shows example printed components. The cross shapes are fasteners as discussed in FIG. 6, and are generally used in a substantially flat configuration. At least some of the other components are designed to be folded, then assembled in a folded configuration.

In some examples, blocks 1204-1208, or blocks 1204-1210, can be performed multiple times, e.g., using the same widget or different widgets, or for a particular part or different parts. For example, extrusion and simplification operations can be alternated to produce a desired shape. In some examples, manufacturing data can be generated (block 1210), and then the user can further modify the model (blocks 1204-1208). This can permit the user to effectively balance model complexity and model cost. In some examples, more-complex models are more faithful to the original 3D model received at block 1202 than are less-complex models, but more-complex models also take more time or money to produce than less-complex models.

In some examples, at block 1212, a manufacturing device can be operated. For example, a die-cutter or laser cutter can be operated based on the determined manufacturing data to cut out one or more parts. Examples are discussed herein, e.g., with reference to FIGS. 8-11. One or more parts can be folded or assembled. One or more folded or assembled parts can then be assembled to each other, e.g., at or using joint mating features, to form a completed physical model (in some examples, one folded or assembled part is the entire physical model). In some examples, the manufacturing device can include at least one of the following: a SILVER BULLET, CRICUT, or other die cutter; a computer numerical control (CNC) mill, CNC engraver, or other CNC machine; a GLOWFORGE or other laser cutter; or a water-jet cutter. In some examples, an SVG file can be imported into a driver program such as SURE CUTS A LOT (SCAL), and the driver program can transmit cutting commands or other manufacturing data to the manufacturing device. In some examples, the parts can be cut out of any flat material, e.g., corrugated cardboard, paperboard, wood or composite sheets (e.g., plywood or medium-density fiberboard, MDF), or sheet metal. In some examples, the flat material can be substantially rigid or non-stretchable. In some examples, block 1212 can include drilling or otherwise removing material from parts, e.g., for revolute joints (e.g., FIG. 6(b)).

Some examples include processes including blocks 1202-1208, or blocks 1202-1210, or blocks 1202-1212, or blocks 1204-1208, or blocks 1204-1210, or blocks 1204-1212. Some examples include processes including block 1210, or blocks 1210 and 1212, or blocks 1202 and 1210, or blocks 1202,1210, and 1212. Some examples include presenting user interfaces. Some examples include receiving a model, e.g., a 3D model (at block 1202), and determining manufacturing data (block 1210). In some examples, block 1202 includes receiving a modified model. Some examples include receiving a model (at block 1202), e.g., a modified model or other model type described herein, determining manufacturing data (block 1210), and operating a manufacturing device (block 1212).

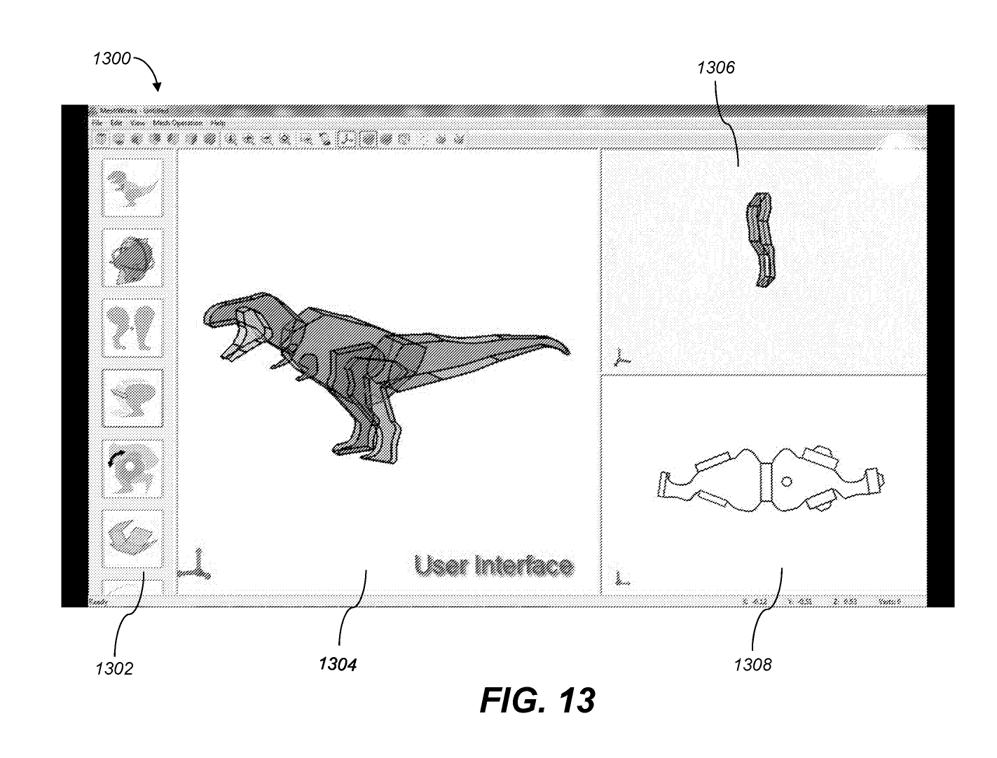

FIG. 13 is a graphical representation of a screenshot of an example user interface 1300. FIG. 13 shows an operation selector 1302 on the left, a 3D model area 1304 at the center, a widget area 1306 at the upper right, and a manufacturing-data area 1308 at the lower right. The areas 1304,1306,1308 are named for clarity of explanation, but the names are not limiting. For example, a widget can be presented in the model area 1304 in addition to or instead of in the widget area 1306. Throughout the discussion of FIGS. 13-29, a T-rex is used as a nonlimiting example model.

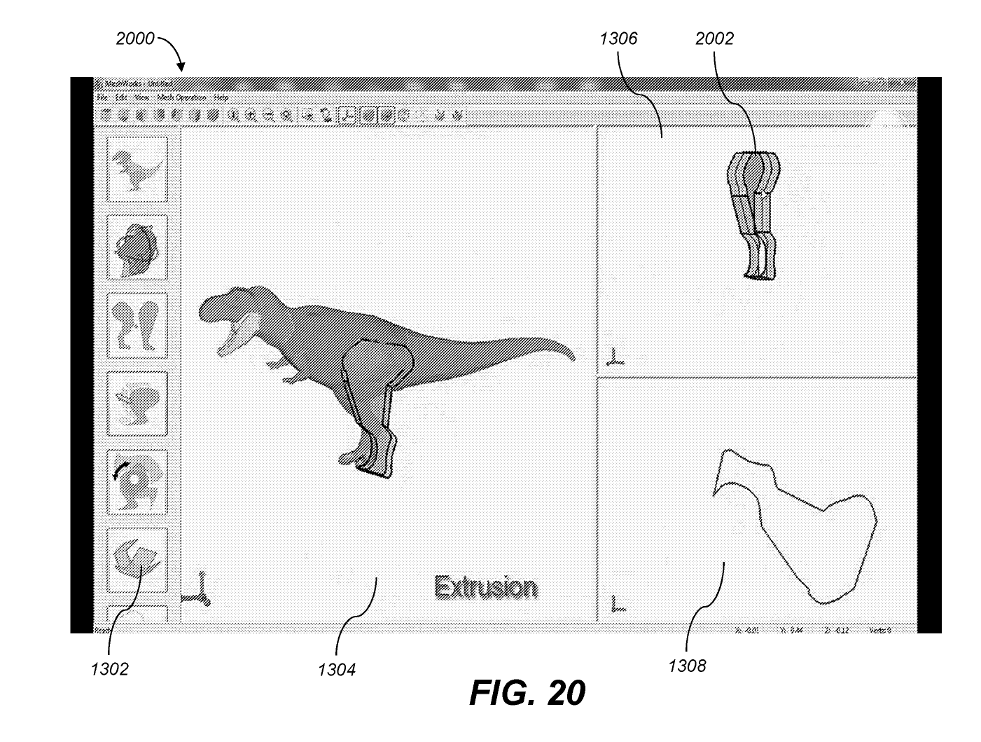

Discussion of mouse or trackball input is presented for clarity of explanation, but this is not limiting. Keyboard input or touch input can additionally or alternatively be used. For example, extrusion thickness in FIG. 20 can be controlled with keyboard presses such as arrow keys or PgUp/PgDn, or pinch or swipe gestures on a touch input device, in addition to or instead of with mouse drag actions. Moreover, in some examples, at least one of the areas 1304, 1306, 1308 can be responsive to inputs to control position, rotation, and size of the contents displayed therein or of a viewpoint on the virtual object or part being displayed (these settings are referred to individually or collectively as a “view”). In some examples, at least one of the areas 1304, 1306, 1308 is responsive to view changes in another of the areas 1304, 1306, 1308. For example, when the model is rotated in the model area 1304, the part model can additionally be rotated in the widget area 1306. In some examples, each of the areas 1304, 1306, 1308 has an independently-controllable view.

In various examples, changes in one area 1304, 1306, 1308 are automatically reflected in other(s) of the areas 1304, 1306, 1308. In some examples, changes in any area 1304, 1306, 1308 are automatically reflected in all of the other areas 1304, 1306, 1308. Various examples of interfaces such as interface 1300 can provide realtime or near-realtime feedback to users. Providing the separate areas 1304 and 1306 can provide effective visual feedback to users while also permitting ready manipulation of a 3D model. Various examples permit users to adjust the 3D models to achieve a desired balance of model complexity, manufacturing time, and shape accuracy.

The selector 1302 permits a user of the interface 1300 to select a desired operation from among the operations described herein. In some examples, any operation can be selected from selector 1302 in any order. In the illustrated example, from top to bottom, selector 1302 includes graphical buttons representing segmentation, contour generation, geometric simplification, extrusion, articulation (motion) specification, unfolding, and contour completion (partially obscured by the status bar).

In the example of FIG. 13, model area 1304 shows a 3D model processed according to examples herein. The user can rotate, translate, or zoom the view in model area 1304, e.g., using mouse drag operations or a 3D input device such as a SPACEBALL or SPACEMOUSE. Widget area 1306 shows a part of the model currently selected in model area 1304, in this example the left leg of the depicted Tyrannosaurus rex (T-rex). The manufacturing-data area 1308 shows information relevant to manufacturing or manufacturability of the selected part, in this example the outline of an unfolded part that can be cut out of a sheet of material and folded to form a physical realization of the model portion shown in widget area 1306. The outline of the unfolded part is an example of a planar model.

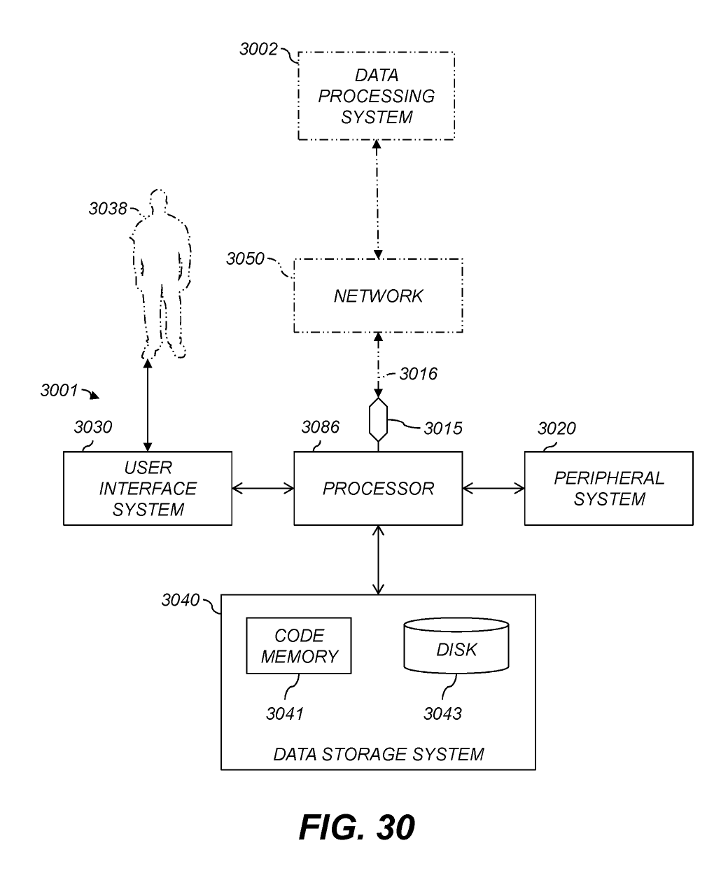

In some examples herein, widgets include interactive graphical depictions of control points of models or portions thereof. For example, a thickness widget can graphically depict a “thickness” value, e.g., a number of millimeters thick that a particular part is. A cutting-plane widget can graphically depict an input parameter to a contouring algorithm. The input parameter can be, e.g., a vector normal to the desired cutting plane. A control program (e.g., in code memory 3041, FIG. 30) depicting or operating widgets can perform at least one of: receiving user input, determining a change in a variable based at least in part on the user input, applying the change, e.g., to the variable stored in a memory (e.g., data storage system 3040, FIG. 30), or providing the change or the changed variable value to other code, e.g., by transmitting, sending, or posting an event, or by invoking a callback. The code receiving the change or changed variable value can then update the 3D model or take other actions based at least in part on the change or value.

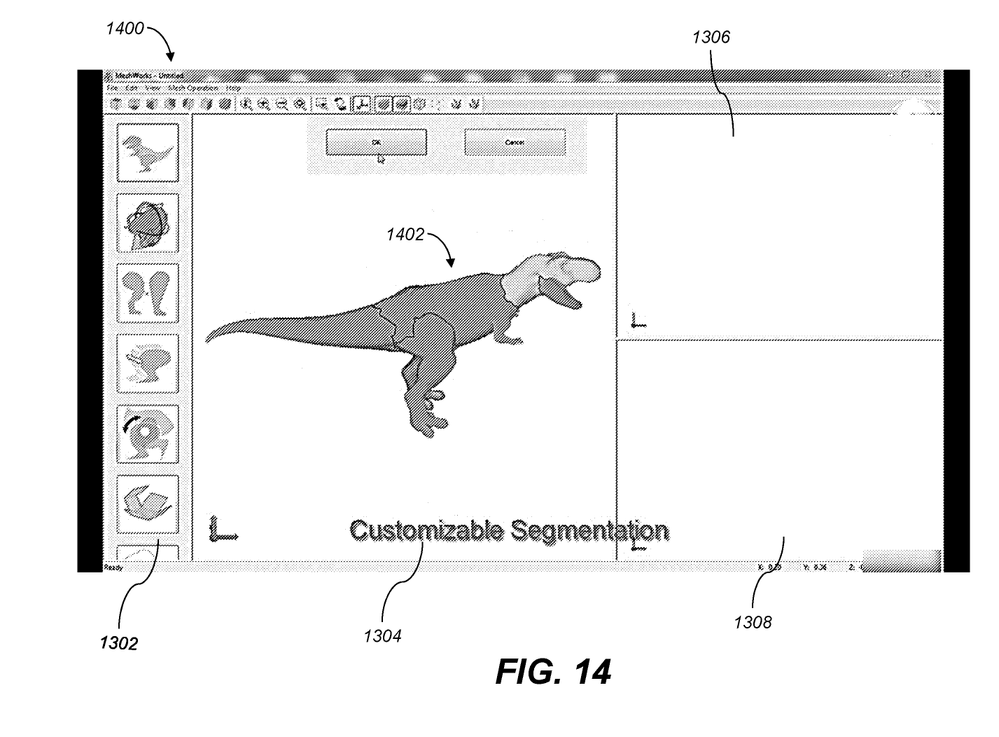

FIG. 14 is a graphical representation of a screenshot of an example user interface 1400. In the model area 1304, the 3D model of the T-rex is shown. In this example, the model 1402 is a widget that can receive mouse drag events to draw suggested segmentation contours, e.g., strokes on the model.

Some examples apply “dot scissor” techniques to capture local concave shape features using concavity-aware harmonic fields, and to select the best cutting boundaries using a voting scheme. A concavity-aware harmonic field is a harmonic field over a surface (e.g., a mesh or other 3D model), with the isolines of the field more concentrated in concave areas of the surface than in flat or convex areas of the model. A concavity-aware harmonic field can be computed by solving a Poisson equation, e.g., in a least-squares manner, over the Laplacian matrix of the graph. The Laplacian matrix has rows and columns for the vertices of the graph. Elements of the matrix corresponding to vertices connected by an edge can have a weight value correlated with the concavity at that edge. Concavity can be determined using the Gaussian curvature, the positions of the connected vertices, and the surface normals at those vertices (e.g., if the normals generally point towards each other, the surface is concave along that edge).

In some examples herein, the designer first specifies a stroke on the model (a suggested segmentation contour, e.g., at the base of the T-rex's neck) that the partitioning curves are expected or preferred to pass through. A concavity-aware harmonic field is then computed by using the user's specified stroke as constraints. A set of candidate curves are computed upon the harmonic field via extracting iso-value curves of the harmonic field. These iso-value curves (“isolines”) are candidate partitioning curves. The same voting scheme as in dot scissor can then be used to select a preferred partitioning curve according to the curve length and the distance to user's stroke. For example, mathematical optimization can be used, given a score function that penalizes length and that penalizes distance from the stroke. Additionally or alternatively, a plurality of candidates (e.g., the iso-value curves) can be evaluated using the score function, and the one having the highest score (or lowest penalty) can be selected. In some examples, the score or vote can be based on at least one of: concavity along an isoline; length (“tightness”) of the isoline; or proximity to the stroke (e.g., mean distance between the stroke and the isoline, e.g., along normals to the stroke or to the isoline).

Compared with the “dot scissor” approach used in some prior schemes, our system with strokes rather than dots representation, affords more of the user intent to be captured by the design process. Besides, the system also allows the users to continue interacting with strokes in the same region without actually partitioning the model. This scheme also increases the flexibility and convenience in using our tool.

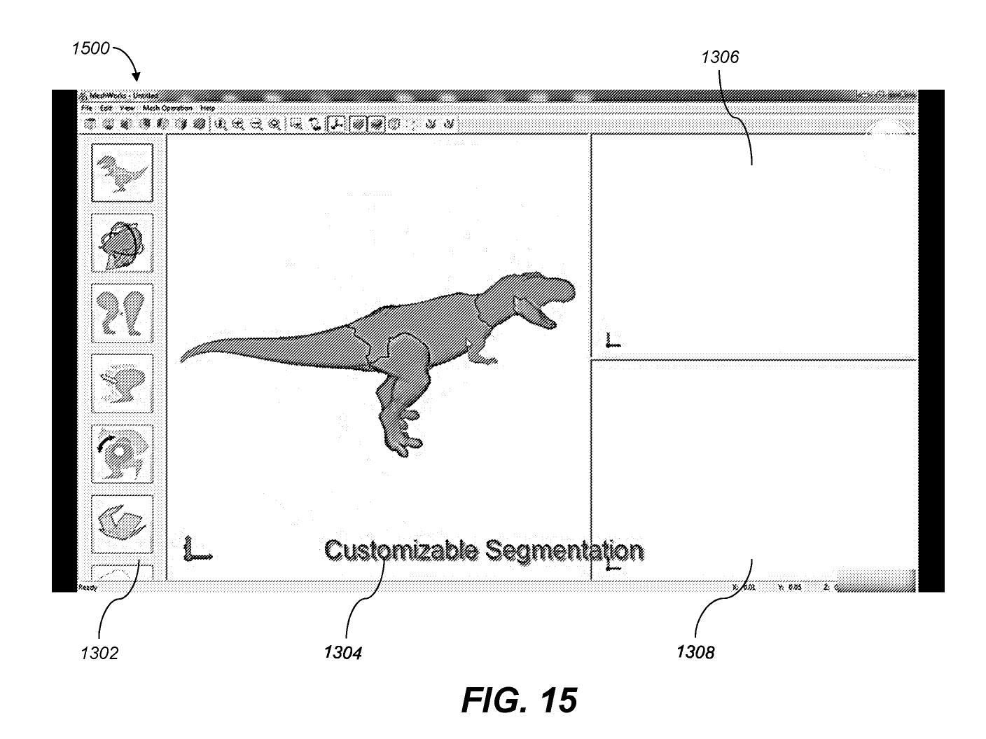

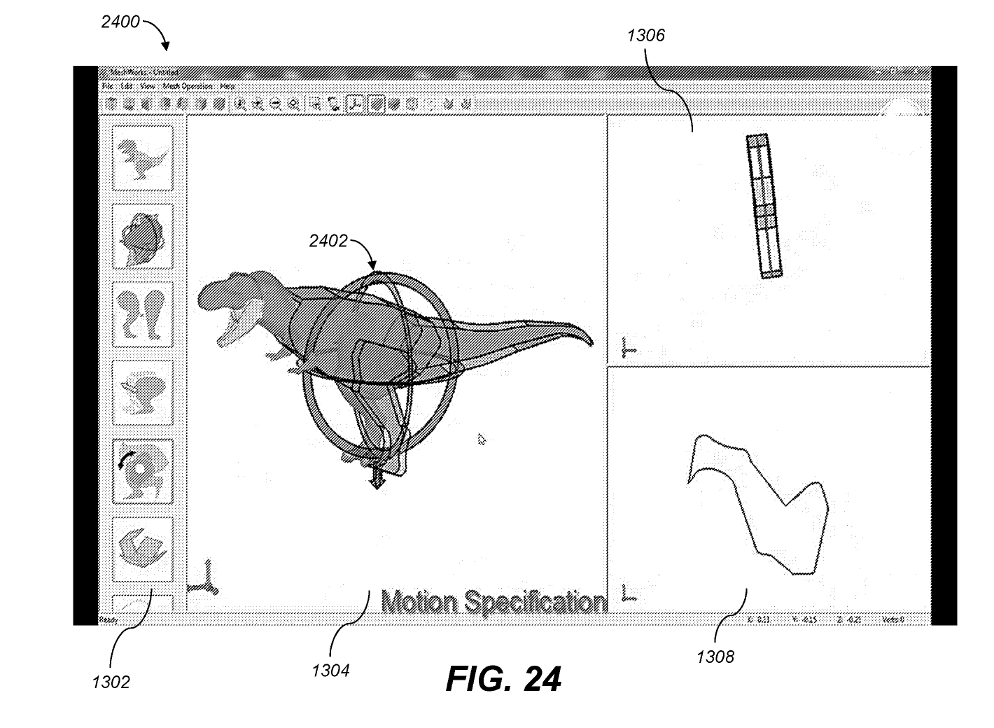

FIG. 15 is a graphical representation of a screenshot of an example user interface 1500. FIG. 15 shows a subsequent stage of segmentation of the T-rex model. In some examples, segmentation includes determining spatial relationships between adjacent segmented portions of the three-dimensional model. The spatial relationships can be used in determining joint locations (e.g., FIG. 24).

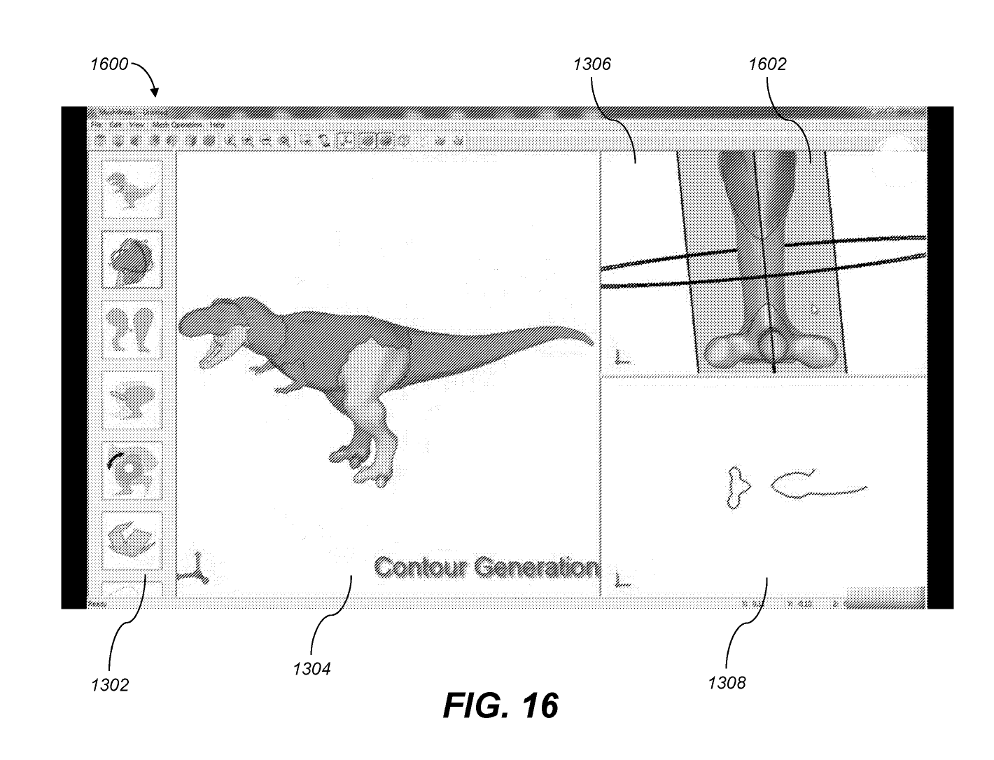

FIG. 16 is a graphical representation of a screenshot of an example user interface 1600. Model area 1302 can receive a selection of a segmented portion of the model, in this example the left leg. Widget area 1306 can then present widget 1602 permitting selection of a cutting plane for the selected portion. Examples are discussed with reference to FIG. 3. Manufacturing-data area 1308 can present the contour determined by the cutting plane. FIG. 16 shows an example of a transverse cutting plane, resulting in the T-rex's toes being disconnected from the rest of the leg, as shown in area 1308. Contour generation as in FIGS. 16-19 is also discussed with reference to FIGS. 3, 4, and 14.

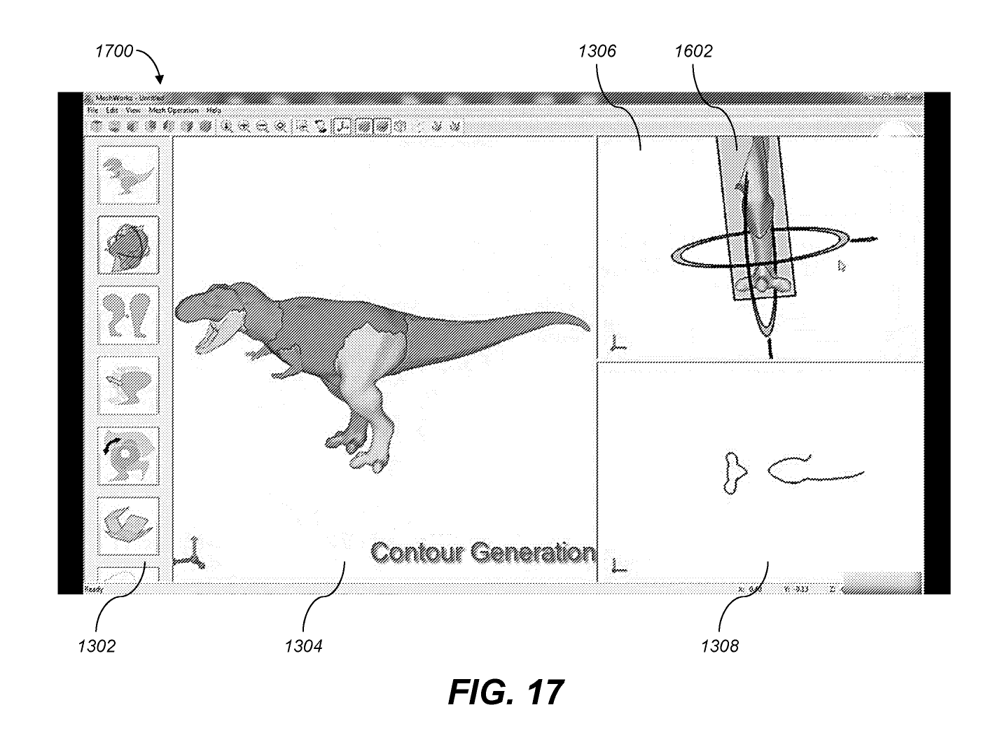

FIG. 17 is a graphical representation of a screenshot of an example user interface. In FIG. 17, the view in area 1306 has been zoomed out so that more of the part and of widget 1602 are visible. As shown, widget 1602 includes at least one ring, each ring permitting rotation of the selected part of the model in the plane of the ring. In some examples, rotating one ring moves other ring(s) as well as moving the cutting plane. In this example, since the cutting plane is two-dimensional, rotation around the normal of the cutting plane does not affect the resulting contour. Therefore, two variables are sufficient to specify the orientation of the cutting plane in space, so two rings are present in widget 1602. In some examples of widgets, three rings can be used.

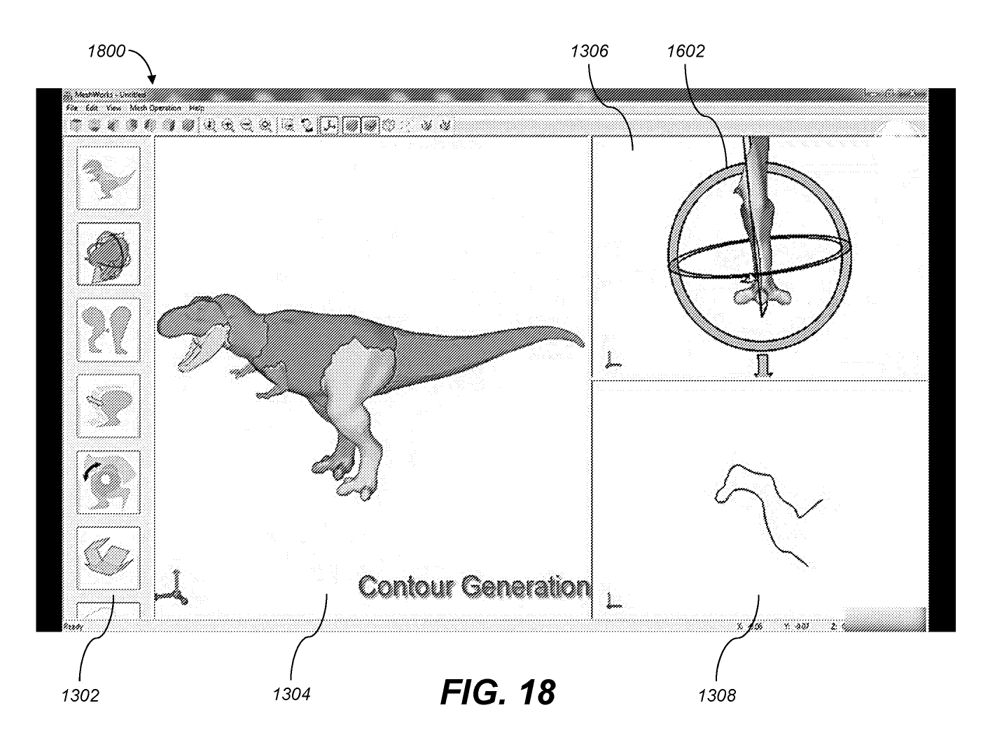

FIG. 18 is a graphical representation of a screenshot of an example user interface. In FIG. 18, the widget 1602 has received user input to rotate about 90 degrees around a substantially vertical axis. As a result, area 1308 now shows a continuous open contour.

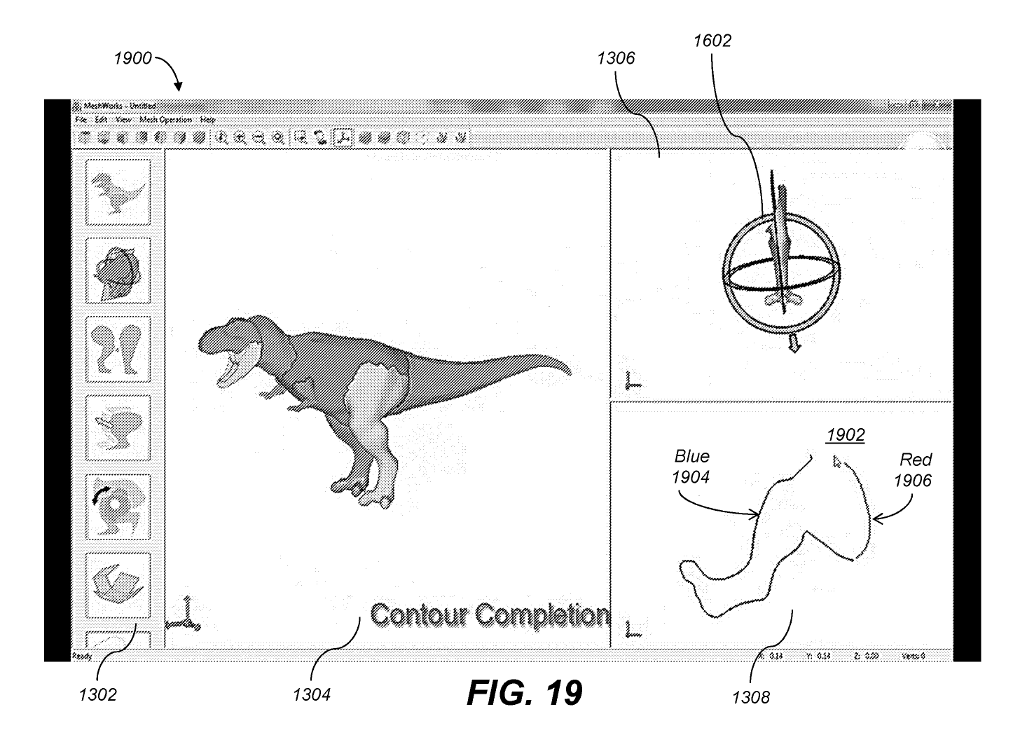

FIG. 19 is a graphical representation of a screenshot of an example user interface 1900. In manufacturing-data area 1308, a widget 1902 is presented permitting the user to complete an incomplete contour 1904 (blue) with an outline portion 1906 (red). Widget 1902 can receive, e.g., hand-drawn mouse strokes or inputs of, e.g., control points of Bezier or other curves. Widget 1902 can automatically connect endpoints of outline portion 1906 with endpoints of incomplete contour 1904 that are within a selected distance, in some examples. Examples are discussed herein, e.g., with reference to FIG. 3.

FIG. 20 is a graphical representation of a screenshot of an example user interface 2000. In widget area 1306 is presented widget 2002 representing an extrusion of the completed contour indicated in manufacturing-data area 1308. Widget 2002 can receive drag or other input to change the thickness of the extrusion of the contour. The display in model area 1304 can update in realtime or near realtime as the widget 2002 changes the thickness of the part. Extrusion is also discussed with reference to FIG. 3. The contour in widget area 1308 can be the result of contour processing, e.g., as discussed herein with reference to FIGS. 3 and 4.

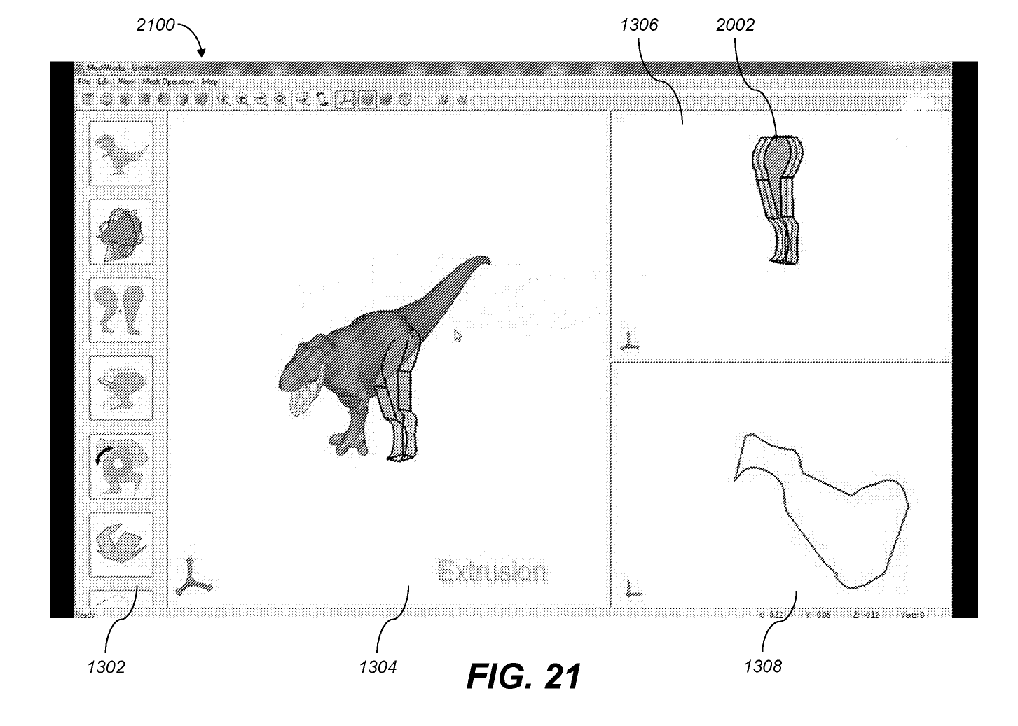

FIG. 21 is a graphical representation of a screenshot of an example user interface. FIG. 21 shows, at widget 2002, an example of a thinner extrusion of the leg shown in FIG. 20.

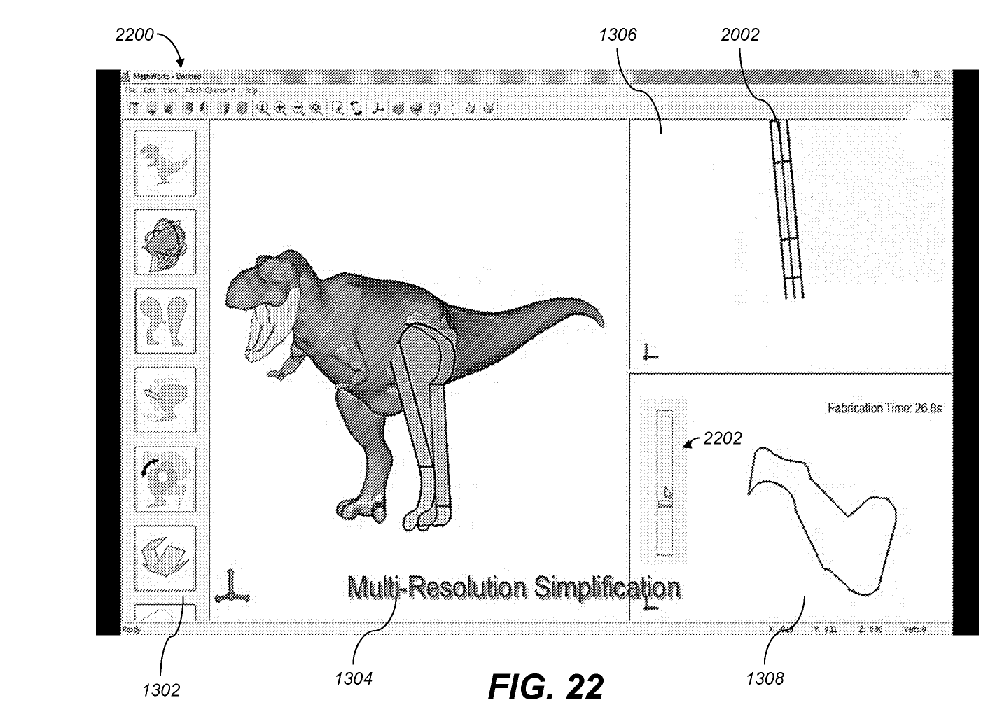

FIG. 22 is a graphical representation of a screenshot of an example user interface 2200. In widget area 1306 is presented an extrusion-thickness widget 2002, e.g., as in FIG. 20. In data area 1308 is presented a simplification widget 2202, in this example a scrollbar. Widget 2202 can receive inputs from the user indicating a degree of simplification (e.g., a region count M) desired with respect to the part selected in the model area 1304. As the user updates the widget 2202, a simplified contour can be calculated for a corresponding degree of simplification. For example, the widget 2202 can permit a user to select a value of M to be used as discussed herein with reference to FIG. 4. The simplified contour can be presented in data area 1308. In the illustrated example, an estimated fabrication time for the simplified contour is also presented in data area 1308 (“Fabrication Time: 26.8s” in the illustration). This can permit users to adjust the simplification in realtime to balance fidelity to the original model with manufacturing time. Simplification is discussed with reference to FIG. 4. In some examples, the user can select the value of M independently for each component of the model. Additional widgets can be presented to permit the user to adjust other parameters, e.g., 6, in some examples.

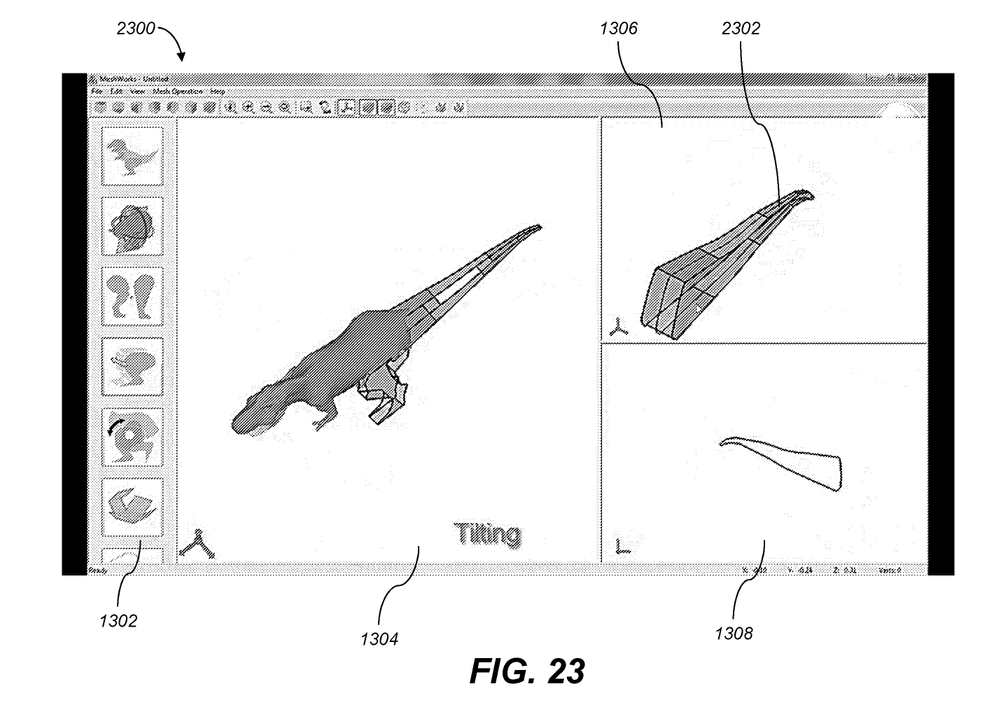

FIG. 23 is a graphical representation of a screenshot of an example user interface 2300. In widget area 1306 is presented widget 2302 permitting “tilting” of an extrusion, i.e., varying of the extrusion thickness as a function of position in the plane normal to the direction of extrusion. Tilting is discussed further with reference to FIG. 3. In the illustrated example, model area 1304 has received a selection of the T-rex's tail. Widget 2302 depicts the tail, and receives input to adjust thickness. In the illustrated example, the tip of the tail is thinner than the base of the tail.

FIG. 24 is a graphical representation of a screenshot of an example user interface 2400. In the illustrated example, model area 1304 includes a widget 2402 permitting the user to specify a direction of motion of the selected part (left leg) with respect to an adjacent part (torso). In this example, widget 2402 is positioned to indicate that the left leg can rotate forwards and backwards, e.g., about an axis extending through both legs and the torso perpendicular to the long axis of the T-rex. Motion specification is discussed further with reference to FIGS. 5 and 6. In some examples, widget 2402 includes rings that can be operated to indicate a direction of rotation or other motion (e.g., linear motion), to indicate a direction of an axis of rotation or motion, or to rotate or translate an axis of motion. In some examples, widget 2402 can be dragged or otherwise translated in the virtual space being viewed in model area 1304 to change a location of an axis or joint.

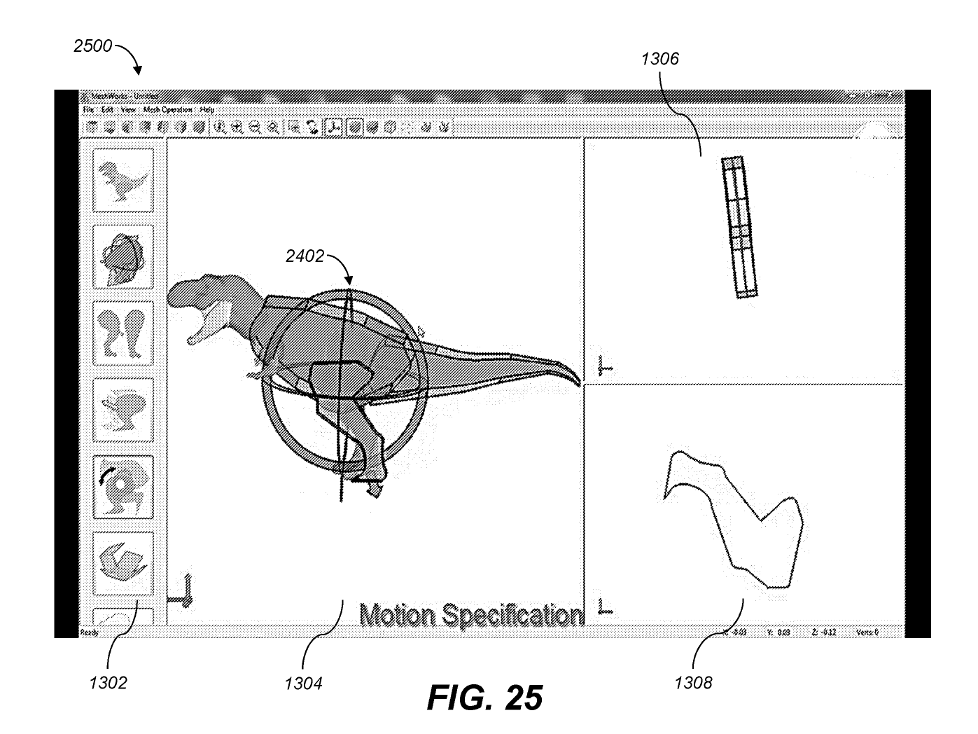

FIG. 25 is a graphical representation of a screenshot of an example user interface 2500. FIG. 25 shows the view of FIG. 24 after the model area 1304 has received and processed inputs to rotate the view. As shown, the widget 2402 rotates with the model.

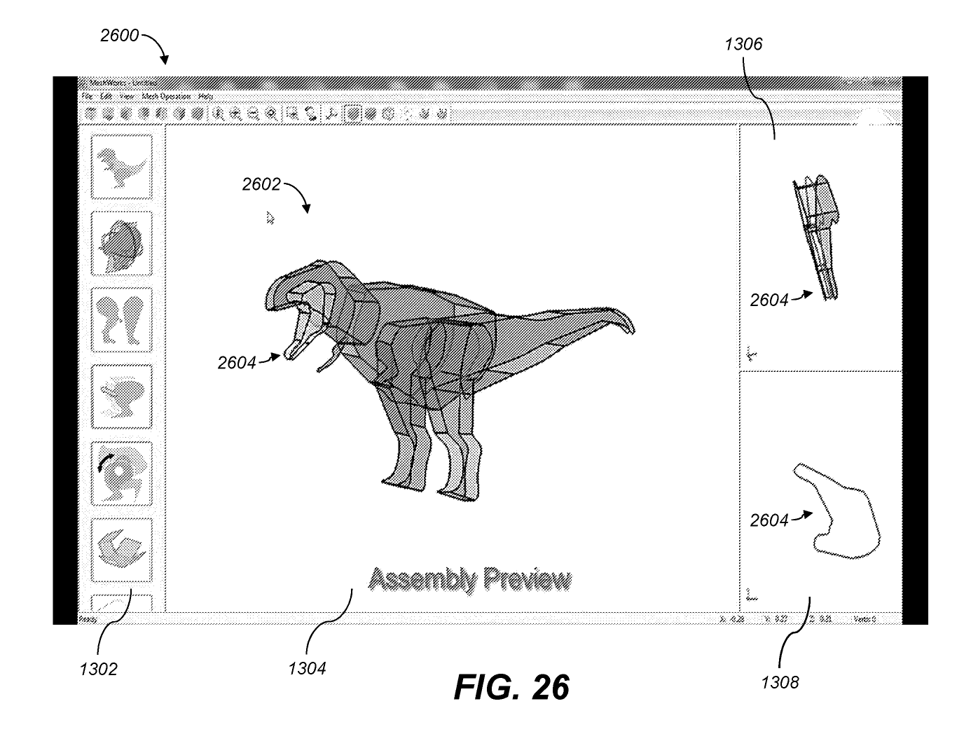

FIG. 26 is a graphical representation of a screenshot of an example user interface 2600. FIG. 26 shows an “assembly preview” view in which model area 1304 shows the fully modified model 2602 produced as described herein with reference to FIGS. 2-7B. Each segment of the original model has been replaced by a corresponding extruded part. In this example, the T-Rex's lower jaw 2604 is selected. The widget area 1306 shows the jaw 2604 by itself, and the data area 1308 shows the outline of the jaw 2604.

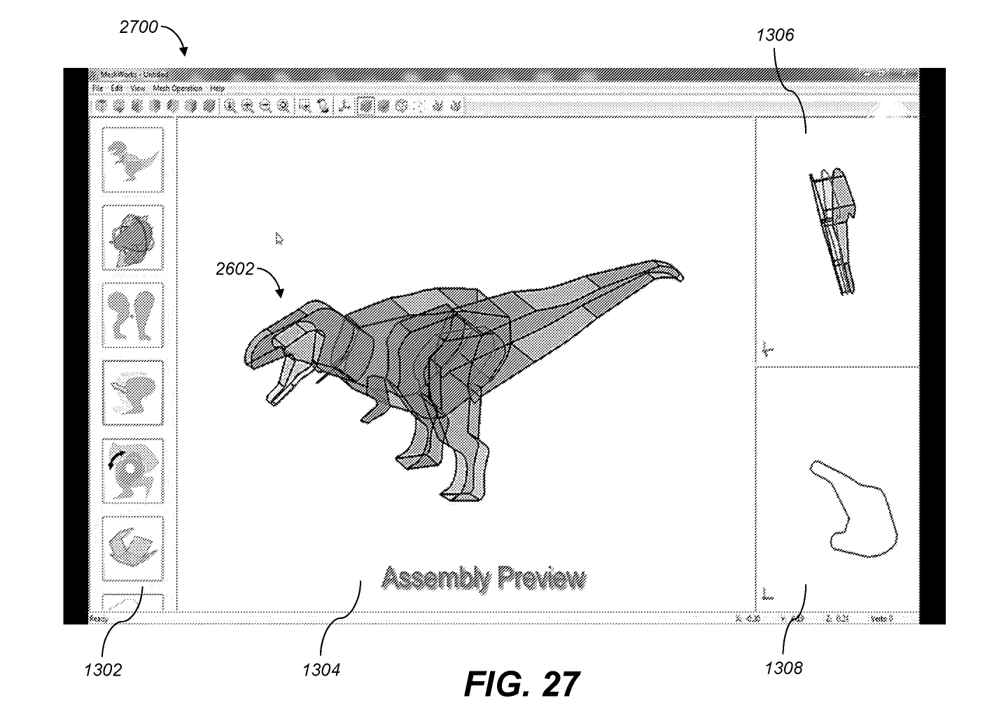

FIG. 27 is a graphical representation of a screenshot of an example user interface 2700. FIG. 27 shows a different view of model 2602 than does FIG. 26.

FIG. 28 is a graphical representation of a screenshot of an example user interface 2800. In data area 1308 is presented an unfolded contour 2802 of the selected part, in this example the left leg 2804. As shown, the widget 2402 is also visible in this example. In the illustrated example, the unfolded contour 2802 includes tabs and slots to retain the part in a 3D shape (volumetric, e.g., substantially not flat) once folded, and includes a circular hole 2806 for connection to the torso piece.

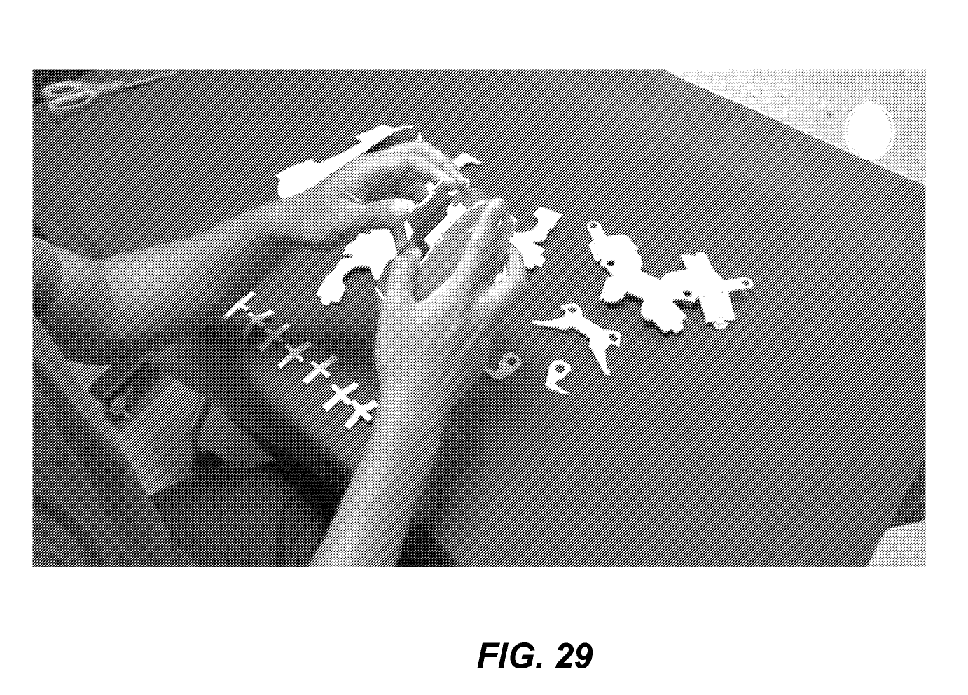

FIG. 29 is a graphical representation of a photograph of a person assembling a physical model that was produced according to a tested example according to manufacturing data determined based on a modified 3D model as described herein. The plus-shaped pieces are revolute-joint connectors (FIG. 6, at (a)). Several unfolded pieces are visible. The person is folding the cut-out pieces, and then retaining the fold in position by inserting tabs into slots. In a tested example, the person assembled the physical model in approximately six minutes.

FIG. 30 is a high-level diagram showing the components of an example data-processing system 3001 for analyzing data and performing other analyses described herein, and related components. The system 3001 includes a processor 3086, a peripheral system 3020, a user interface system 3030, and a data storage system 3040. The peripheral system 3020, the user interface system 3030, and the data storage system 3040 are communicatively connected to the processor 3086. Processor 3086 can be communicatively connected to network 3050 (shown in phantom), e.g., the Internet or a leased line, as discussed below. Devices shown in FIG. 2, FIG. 8 (at (a)), or FIG. 11, devices configured to carry out functions described with reference to FIG. 12, or devices configured to prevent user interfaces such as those depicted in FIGS. 13-28, can each include one or more of systems 3086, 3020, 3030, 3040, and can each connect to one or more network(s) 3050. Processor 3086, and other processing devices described herein, can each include one or more microprocessors, microcontrollers, field-programmable gate arrays (FPGAs), application-specific integrated circuits (ASICs), programmable logic devices (PLDs), programmable logic arrays (PLAs), programmable array logic devices (PALs), or digital signal processors (DSPs).

Processor 3086 can implement processes of various aspects described herein, e.g., with reference to any of FIGS. 1-12. Processor 3086 and related components can, e.g., carry out processes for operating user interfaces, receiving user input, modifying 3D models, providing manufacturing data, or operating a manufacturing device to produce components of a physical model that embodies a modified 3D model.

Processor 3086 can be or include one or more device(s) for automatically operating on data, e.g., a central processing unit (CPU), microcontroller (MCU), desktop computer, laptop computer, mainframe computer, personal digital assistant, digital camera, cellular phone, smartphone, or any other device for processing data, managing data, or handling data, whether implemented with electrical, magnetic, optical, biological components, or otherwise.

The phrase “communicatively connected” includes any type of connection, wired or wireless, for communicating data between devices or processors. These devices or processors can be located in physical proximity or not. For example, subsystems such as peripheral system 3020, user interface system 3030, and data storage system 3040 are shown separately from the processor 3086 but can be stored completely or partially within the processor 3086.

The peripheral system 3020 can include or be communicatively connected with one or more devices configured or otherwise adapted to provide digital content records to the processor 3086 or to take action in response to processor 186. For example, the peripheral system 3020 can include digital still cameras, digital video cameras, cellular phones, or other data processors. The processor 3086, upon receipt of digital content records from a device in the peripheral system 3020, can store such digital content records in the data storage system 3040.

The user interface system 3030 can convey information in either direction, or in both directions, between a user 3038 and the processor 3086 or other components of system 3001. The user interface system 3030 can include a mouse, a keyboard, another computer (connected, e.g., via a network or a null-modem cable), or any device or combination of devices from which data is input to the processor 3086. The user interface system 3030 also can include a display device, a processor-accessible memory, or any device or combination of devices to which data is output by the processor 3086. The user interface system 3030 and the data storage system 3040 can share a processor-accessible memory. Some examples can include receiving user input (block 1206) from user 3038. Some examples can include providing cut parts from the manufacturing device to user 3038 for folding, e.g., as in FIG. 29.

In various aspects, processor 3086 includes or is connected to communication interface 3015 that is coupled via network link 3016 (shown in phantom) to network 3050. For example, communication interface 3015 can include an integrated services digital network (ISDN) terminal adapter or a modem to communicate data via a telephone line; a network interface to communicate data via a local-area network (LAN), e.g., an Ethernet LAN, or wide-area network (WAN); or a radio to communicate data via a wireless link, e.g., WIFI or GSM. Communication interface 3015 sends and receives electrical, electromagnetic, or optical signals that carry digital or analog data streams representing various types of information across network link 3016 to network 3050. Network link 3016 can be connected to network 3050 via a switch, gateway, hub, router, or other networking device.

In various aspects, system 3001 can communicate, e.g., via network 3050, with a data processing system 3002, which can include the same types of components as system 3001 but is not required to be identical thereto. Systems 3001, 3002 can be communicatively connected via the network 3050. Each system 3001, 3002 can execute computer program instructions to, e.g., present user interfaces, receive user inputs, modify models, determine manufacturing data, operate a manufacturing device, or any combination thereof.

Processor 3086 can send messages and receive data, including program code, through network 3050, network link 3016, and communication interface 3015. For example, a server can store requested code for an application program (e.g., a JAVA applet) on a tangible non-volatile computer-readable storage medium to which it is connected. The server can retrieve the code from the medium and transmit it through network 3050 to communication interface 3015. The received code can be executed by processor 3086 as it is received, or stored in data storage system 3040 for later execution.

Data storage system 3040 can include or be communicatively connected with one or more processor-accessible memories configured or otherwise adapted to store information. The memories can be, e.g., within a chassis or as parts of a distributed system. The phrase “processor-accessible memory” is intended to include any data storage device to or from which processor 3086 can transfer data (using appropriate components of peripheral system 3020), whether volatile or nonvolatile; removable or fixed; electronic, magnetic, optical, chemical, mechanical, or otherwise. Example processor-accessible memories include but are not limited to: registers, floppy disks, hard disks, tapes, bar codes, Compact Discs, DVDs, read-only memories (ROM), erasable programmable read-only memories (EPROM, EEPROM, or Flash), and random-access memories (RAMs). One of the processor-accessible memories in the data storage system 3040 can be a tangible non-transitory computer-readable storage medium, i.e., a non-transitory device or article of manufacture that participates in storing instructions that can be provided to processor 3086 for execution.

In an example, data storage system 3040 includes code memory 3041, e.g., a RAM, and disk 3043, e.g., a tangible computer-readable rotational storage device or medium such as a hard drive. Computer program instructions are read into code memory 3041 from disk 3043. Processor 3086 then executes one or more sequences of the computer program instructions loaded into code memory 3041, as a result performing process steps described herein. In this way, processor 3086 carries out a computer implemented process. For example, steps of methods described herein, blocks of the flowchart illustrations or block diagrams herein, and combinations of those, can be implemented by computer program instructions. Code memory 3041 can also store data, or can store only code.

In the illustrated example, systems 3001 or 3002 can be computing nodes in a cluster computing system, e.g., a cloud service or other cluster system (“computing cluster” or “cluster”) having several discrete computing nodes (systems 3001, 3002) that work together to accomplish a computing task assigned to the cluster as a whole. In some examples, at least one of systems 3001, 3002 can be a client of a cluster and can submit jobs to the cluster and/or receive job results from the cluster. Nodes in the cluster can, e.g., share resources, balance load, increase performance, and/or provide fail-over support and/or redundancy. Additionally or alternatively, at least one of systems 3001, 3002 can communicate with the cluster, e.g., with a load-balancing or job-coordination device of the cluster, and the cluster or components thereof can route transmissions to individual nodes.

Some cluster-based systems can have all or a portion of the cluster deployed in the cloud. Cloud computing allows for computing resources to be provided as services rather than a deliverable product. For example, in a cloud-computing environment, resources such as computing power, software, information, and/or network connectivity are provided (for example, through a rental agreement) over a network, such as the Internet. As used herein, the term “computing” used with reference to computing clusters, nodes, and jobs refers generally to computation, data manipulation, and/or other programmatically-controlled operations. The term “resource” used with reference to clusters, nodes, and jobs refers generally to any commodity and/or service provided by the cluster for use by jobs. Resources can include processor cycles, disk space, random-access memory (RAM) space, network bandwidth (uplink, downlink, or both), prioritized network channels such as those used for communications with quality-of-service (QoS) guarantees, backup tape space and/or mounting/unmounting services, electrical power, etc.

Various aspects herein may be embodied as computer program products including computer readable program code (“program code”) stored on a computer readable medium, e.g., a tangible non-transitory computer storage medium or a communication medium. A computer storage medium can include tangible storage units such as volatile memory, nonvolatile memory, or other persistent or auxiliary computer storage media, removable and non-removable computer storage media implemented in any method or technology for storage of information such as computer-readable instructions, data structures, program modules, or other data. A computer storage medium can be manufactured as is conventional for such articles, e.g., by pressing a CD-ROM or electronically writing data into a Flash memory. In contrast to computer storage media, communication media may embody computer-readable instructions, data structures, program modules, or other data in a modulated data signal, such as a carrier wave or other transmission mechanism. As defined herein, computer storage media do not include communication media. That is, computer storage media do not include communications media consisting solely of a modulated data signal, a carrier wave, or a propagated signal, per se.

The program code includes computer program instructions that can be loaded into processor 3086 (and possibly also other processors), and that, when loaded into processor 3086, cause functions, acts, or operational steps of various aspects herein to be performed by processor 3086 (or other processor). Computer program code for carrying out operations for various aspects described herein may be written in any combination of one or more programming language(s), and can be loaded from disk 3043 into code memory 3041 for execution. The program code may execute, e.g., entirely on processor 3086, partly on processor 3086 and partly on a remote computer connected to network 3050, or entirely on the remote computer.

### Example Clauses

A: A system, comprising: a user interface having a display device and a user-operable input device; at least one processor; and a memory communicatively coupled to the at least one processor and storing instructions that, when executed by the at least one processor, cause the at least one processor to perform operations comprising: receiving user input via the user-operable input device; modifying a three-dimensional model based at least in part on the user input to provide a modified three-dimensional model; and determining planar manufacturing data based at least in part on the modified three-dimensional model.

B: The system according to paragraph A, further comprising a manufacturing device, the operations further comprising operating the manufacturing device based at least in part on the manufacturing data to produce at least one component associated with the three-dimensional model.

C: The system according to paragraph B, wherein: the manufacturing data comprises respective outlines of one or more planar models; the manufacturing device comprises at least one of a laser cutter, a die cutter, a water jet, a mill, or an engraver; and the operations comprise causing the manufacturing device to cut the one or more planar models out of at least one sheet of material in accordance with the respective outlines.

D: The system according to any of paragraphs A-C, wherein the operations further comprise: receiving the user input designating a suggested segmentation contour comprising at least one stroke on a surface of the three-dimensional model; determining a plurality of candidate partitioning curves based at least in part on the stroke and a concavity of the surface in the vicinity of the at least one stroke; selecting a preferred partitioning curve from the plurality of candidate partitioning curves based at least in part on at least one of: concavities along curves of the plurality of candidate partitioning curves, lengths of the curves. or proximities of the curves to the at least one stroke; and determining the modified three-dimensional model comprising a plurality of mesh segments divided along the preferred partitioning curve.

E: The system according to paragraph D, wherein the operations further comprise: receiving the user input designating a motion relationship between a first segment of the plurality of mesh segments and a second, different segment of the plurality of mesh segments, wherein the motion relationship comprises at least one of an axial-rotational relationship, a translational relationship, or a spherical-rotational relationship; determining a first joint location in the first segment based at least in part on the motion relationship; determining a second joint location in the second segment based at least in part on the motion relationship; and determining the modified three-dimensional model including joint mating features associated with the first joint location and the second joint location.

F: The system according to any of paragraphs A-E, wherein the operations further comprise: receiving the user input designating a location and an orientation of a cutting plane; and determining a contour of the three-dimensional model intersecting with the cutting plane.

G: The system according to paragraph F, wherein the contour is an open contour and the operations further comprise: presenting, via the display device, a visual representation of the contour; receiving the user input designating a contour segment; and determining a closed contour comprising the contour and at least one of the contour segment or an approximation of the contour segment.

H: The system according to any of paragraphs A-G, wherein the operations further comprise: receiving the user input designating a thickness and a cutting plane; determining an extrusion of a closed contour normal to the cutting plane and having the designated thickness; and presenting, via the display device, a visual representation of the extrusion.

I: The system according to paragraph H, wherein the operations further comprise: receiving the user input designating a second, different thickness; determining the extrusion of the closed contour normal to the cutting plane tapering in thickness across the cutting plane between the designated thickness and the second thickness; and presenting, via the display device, a visual representation of the extrusion.

J: The system according to any of paragraphs A-I, wherein the operations further comprise: determining a region partition and a region count M based on a closed contour; presenting, via the display device, a visual representation of the region partition; receiving the user input indicating a second, different region count; determining a second region partition based on the closed contour and the second region count; and presenting, via the display device, a visual representation of the second region partition;

K: The system according to any of paragraphs A-J, wherein the operations further comprise: receiving the user input designating a cutting plane; determining a contour of a portion of the three-dimensional model in the cutting plane, the contour comprising a plurality of segments; determining the modified three-dimensional model comprising an extrusion of the contour normal to the cutting plane, wherein the determining modified three-dimensional model comprises determining the following elements of the extrusion: a first face substantially parallel to the cutting plane, a second face substantially parallel to the cutting plane, and a plurality of extruded faces extending substantially normal to the cutting plane and associated with respective segments of the plurality of segments; determining a face of the plurality of faces as a connecting face; determining data of a plurality of faces based at least in part on the modified three-dimensional model; and determining the manufacturing data comprising a planar arrangement in which each face of the plurality of faces has substantially no overlap with any other face of the plurality of faces, wherein the manufacturing data comprises the data of the plurality of faces and the data of the plurality of faces comprises: data of the first face, data of the second face, data of the connecting face connected to both the first face and the second face, and data of the remaining extruded faces other than the connecting face, each remaining extruded face connected to at most one of the first face and the second face.

L: A method, comprising: displaying a three-dimensional model on a display device, the three-dimensional model having data of a plurality of primitives and adjacency information associating individual ones of those primitives with each other; receiving user input of a suggested segment contour on the three-dimensional model via a user-operable input device; and determining a segmentation of the three-dimensional model based at least in part on the user input, the data of the primitives, and the adjacency information.

M: The method according to paragraph L, further comprising: receiving the user input comprising at least one stroke on a surface of the three-dimensional model; determining a plurality of candidate partitioning curves based at least in part on the stroke and a concavity of the surface in the vicinity of the at least one stroke; selecting a preferred partitioning curve from the plurality of candidate partitioning curves based at least in part on at least one of: concavities along curves of the plurality of candidate partitioning curves; lengths of the curves; or proximities of the curves to the at least one stroke; and determining the segmentation comprising a plurality of mesh segments divided along the preferred partitioning curve.

N: The method according to paragraph M, further comprising: receiving second user input designating a first segment of the plurality of mesh segments and a cutting plane; determining a contour of the first segment with respect to the cutting plane; determining data of an extrusion of the contour normal to the cutting plane; and presenting, via the display device, a visual representation of the extrusion and a visual representation of a second, different segment of the plurality of mesh segments.

O: A method, comprising: receiving data of a three-dimensional model; and determining data of a planar model based at least in part on: the data of the three-dimensional model, and data of a cutting plane.

P: The method according to paragraph O, further comprising: determining a contour of the three-dimensional model in the cutting plane, the contour comprising a plurality of segments; determining an extrusion of the contour normal to the cutting plane, wherein the extrusion comprises: a first face substantially parallel to the cutting plane, a second face substantially parallel to the cutting plane, and a plurality of extruded faces extending substantially normal to the cutting plane and associated with respective segments of the plurality of segments; determining a face of the plurality of faces as a connecting face; and determining data of a plurality of faces based at least in part on the extrusion; and determining the data of the planar model comprising a planar arrangement in which each face of the plurality of faces has substantially no overlap with any other face of the plurality of faces, wherein the data of the planar model comprises the data of the plurality of faces and the data of the plurality of faces comprises: data of the first face, data of the second face, data of the connecting face connected to both the first face and the second face, and data of the remaining extruded faces other than the connecting face, each remaining extruded face connected to at most one of the first face and the second face.

Q: The method according to paragraph O or P, further comprising: determining a self-overlap of the planar model; and in response to determining the self-overlap, modifying the data of the planar model to determine a second planar model that does not exhibit the self-overlap.

R: The method according to any of paragraphs O-Q, further comprising: receiving data of a second three-dimensional model; receiving data of a spatial relationship between the three-dimensional model and the second three-dimensional model; and determining data of a second planar model based at least in part on: the data of the second three-dimensional model, and data of a second cutting plane.

S: The method according to paragraph R, wherein: the determining the data of the planar model comprises determining at least one joint location in the planar model; and the determining the data of the second planar model comprises determining at least one joint location in the second planar model.

T: The method according to paragraph R or S, further comprising receiving the data of the spatial relationship via a widget presented in a user interface, wherein the spatial relationship comprises at least one of a rotational relationship about an axis, a rotational relationship about a point, or a translational relationship along an axis.

U: A computer-readable medium, e.g., a computer storage medium, having thereon computer-executable instructions, the computer-executable instructions upon execution configuring a computer to perform operations as any of paragraphs A-K recites.

V: A device comprising: a processor; and a computer-readable medium, e.g., a computer storage medium, having thereon computer-executable instructions, the computer-executable instructions upon execution by the processor configuring the device to perform operations as any of paragraphs A-K recites.

W: A system comprising: means for processing; and means for storing having thereon computer-executable instructions, the computer-executable instructions including means to configure the system to carry out a method as any of paragraphs A-K recites.

X: A computer-readable medium, e.g., a computer storage medium, having thereon computer-executable instructions, the computer-executable instructions upon execution configuring a computer to perform operations as any of paragraphs L-N recites.

Y: A device comprising: a processor; and a computer-readable medium, e.g., a computer storage medium, having thereon computer-executable instructions, the computer-executable instructions upon execution by the processor configuring the device to perform operations as any of paragraphs L-N recites.

Z: A system comprising: means for processing; and means for storing having thereon computer-executable instructions, the computer-executable instructions including means to configure the system to carry out a method as any of paragraphs L-N recites.

AA: A computer-readable medium, e.g., a computer storage medium, having thereon computer-executable instructions, the computer-executable instructions upon execution configuring a computer to perform operations as any of paragraphs O-T recites.

AB: A device comprising: a processor; and a computer-readable medium, e.g., a computer storage medium, having thereon computer-executable instructions, the computer-executable instructions upon execution by the processor configuring the device to perform operations as any of paragraphs O-T recites.

AC: A system comprising: means for processing; and means for storing having thereon computer-executable instructions, the computer-executable instructions including means to configure the system to carry out a method as any of paragraphs O-T recites.

### CONCLUSION

In view of the foregoing, various aspects permit determining manufacturable three-dimensional models based on possibly-complex input models, and fabricating components of the manufacturable three-dimensional models. Various aspects can reduce the time or material required to fabricate physical objects, e.g., as discussed with reference to FIG. 8. Various aspects provide determination of manufacturing data, or operation of a manufacturing device. A technical effect is to reduce the complexity (and thus the fabrication time) of components to be assembled into a physical object. A further technical effect is to present a visual representation of the manufacturing data on an electronic display, e.g., as discussed herein with reference to FIG. 2, 11, 13, or 28. Some examples permit determining manufacturing data of a 3D model even in the absence of any a priori information other than the model itself. Some examples operate a manufacturing device to produce components of a physical model corresponding to a modified 3D model.

Some examples of CardBoardiZer permit the designer to customize models through the choice of geometries, articulation, joint motions, and resolutions; quickly fabricate the patterns using cutters, on demand; and complete the model through simple manual or automated folding and assembly. Some example UIs are fast and friendly to use, requiring users only load the digital 3D model, segment the partitions as desired, and specify the motions, after which the system generates the 2D crease-cut-slot patterns ready for cutting, folding and articulation. Compared to traditional manual origami crafting methods, various examples permit rapid customization of desired shapes and augmented motion features, and rapid prototyping by using die-cutting and folding approaches.

Our system is applicable for both novice and experienced designers who have basic computer operation skills. The interaction tools of CardBoardiZer are designed for ease of use and enable users to access complex geometric operations. Operations such as segmentation, contour generation and articulation specification, and shape control can be easily performed by simply stroking on the model, adjusting a control widget, or using a slider bar for different resolutions (e.g., M values). Examples using cardboard or similar building materials permit accessibility, experimentation, and expressiveness by novice users. Cardboard is a low-cost everyday material that users are familiar with and can be easily accessed by novice users. The objects generated by CardBoardiZer are tinkerable in many ways: the objects can be easily adjusted and enhanced by users using color pens, scissors, glue, and Velcro to paint, cut, make holes, and attach other objects or decorative materials (e.g., wheels, levers, textiles, electronics, or LEDs). Tinkering with objects generated by CardBoardiZer and other objects has multiple benefits for both learning and expression as it invites broader participation and deepens the learning outcomes by allowing for a range of new solutions.

Although receiving user input, determining manufacturing data, and other features herein have been described in language specific to structural features or methodological steps, it is to be understood that the subject matter defined in the appended claims is not necessarily limited to the specific features or steps described. Rather, the specific features and steps are disclosed as preferred forms of implementing the claimed aspects.

The operations of the example processes are illustrated in individual blocks and summarized with reference to those blocks. The processes are illustrated as logical flows of blocks, each block of which can represent one or more operations that can be implemented in hardware, software (including firmware, resident software, micro-code, etc.), or a combination thereof. In the context of software, the operations represent computer-executable instructions stored on one or more computer-readable media that, when executed by one or more processors, enable the one or more processors to perform the recited operations. Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, or executed in parallel to implement the described processes. The described processes can be performed by resources associated with one or more computing systems 3001, 3002 or processors 3086, such as one or more internal or external CPUs or GPUs, or one or more pieces of hardware logic such as FPGAs, DSPs, or other types of accelerators.

The methods and processes described above can be embodied in, and fully automated via, software code modules executed by one or more general purpose computers or processors. The code modules can be stored in any type of computer-readable storage medium or other computer storage medium. Some or all of the methods can alternatively be embodied in specialized computer hardware. These aspects can all generally be referred to herein as a “service,” “circuit,” “circuitry,” “module,” or “system.”

Conditional language such as, among others, “can,” “could,” “might” or “may,” unless specifically stated otherwise, are understood within the context to present that certain examples include, while other examples do not include, certain features, elements or steps. Thus, such conditional language is not generally intended to imply that certain features, elements or steps are in any way required for one or more examples or that one or more examples necessarily include logic for deciding, with or without user input or prompting, whether certain features, elements or steps are included or are to be performed in any particular example. The word “or” and the phrase “and/or” are used herein in an inclusive sense unless specifically stated otherwise. Accordingly, conjunctive language such as, but not limited to, at least one of the phrases “X, Y, or Z,” “at least X, Y, or Z,” “at least one of X, Y or Z,” and/or any of those phrases with “and/or” substituted for “or,” unless specifically stated otherwise, is to be understood as signifying that an item, term, etc., can be either X, Y, or Z, or a combination of any elements thereof (e.g., a combination of XY, XZ, YZ, and/or XYZ). As used herein, language such as “one or more Xs” shall be considered synonymous with “at least one X” unless otherwise expressly specified. Any recitation of “one or more Xs” signifies that the described steps, operations, structures, or other features may, e.g., include, or be performed with respect to, exactly one X, or a plurality of Xs, in various examples, and that the described subject matter operates regardless of the number of Xs present.

Any routine descriptions, elements or blocks in the flow diagrams described herein or depicted in the attached figures should be understood as potentially representing modules, segments, or portions of code that include one or more executable instructions for implementing specific logical functions or elements in the routine. Alternate implementations are included within the scope of the examples described herein in which elements or functions can be deleted, or executed out of order from that shown or discussed, including substantially synchronously or in reverse order, depending on the functionality involved as would be understood by those skilled in the art. It should be emphasized that many variations and modifications can be made to the above-described examples, the elements of which are to be understood as being among other acceptable examples. All such modifications and variations are intended to be included herein within the scope of this disclosure and protected by the following claims. Moreover, in the claims, any reference to a group of items provided by a preceding claim clause is a reference to at least some of the items in the group of items, unless specifically stated otherwise.

1. A system, comprising:
a user interface having a display device and a user-operable input device;
at least one processor; and
a memory communicatively coupled to the at least one processor and storing instructions that, when executed by the at least one processor, cause the at least one processor to perform operations comprising:
receiving user input via the user-operable input device;
modifying a three-dimensional model based at least in part on the user input to provide a modified three-dimensional model; and
determining planar manufacturing data based at least in part on the modified three-dimensional model.

2. The system according to claim 1, further comprising a manufacturing device, the operations further comprising operating the manufacturing device based at least in part on the manufacturing data to produce at least one component associated with the three-dimensional model.

3. The system according to claim 2, wherein:
the manufacturing data comprises respective outlines of one or more planar models;
the manufacturing device comprises at least one of a laser cutter, a die cutter, a water jet, a mill, or an engraver; and
the operations comprise causing the manufacturing device to cut the one or more planar models out of at least one sheet of material in accordance with the respective outlines.

4. The system according to claim 1, wherein the operations further comprise:
receiving the user input designating a suggested segmentation contour comprising at least one stroke on a surface of the three-dimensional model;
determining a plurality of candidate partitioning curves based at least in part on the stroke and a concavity of the surface in the vicinity of the at least one stroke;
selecting a preferred partitioning curve from the plurality of candidate partitioning curves based at least in part on at least one of: concavities along curves of the plurality of candidate partitioning curves, lengths of the curves. or proximities of the curves to the at least one stroke; and
determining the modified three-dimensional model comprising a plurality of mesh segments divided along the preferred partitioning curve.

5. The system according to claim 4, wherein the operations further comprise:
receiving the user input designating a motion relationship between a first segment of the plurality of mesh segments and a second, different segment of the plurality of mesh segments, wherein the motion relationship comprises at least one of an axial-rotational relationship, a translational relationship, or a spherical-rotational relationship;
determining a first joint location in the first segment based at least in part on the motion relationship;
determining a second joint location in the second segment based at least in part on the motion relationship; and
determining the modified three-dimensional model including joint mating features associated with the first joint location and the second joint location.

6. The system according to claim 1, wherein the operations further comprise:
receiving the user input designating a location and an orientation of a cutting plane; and
determining a contour of the three-dimensional model intersecting with the cutting plane.

7. The system according to claim 6, wherein the contour is an open contour and the operations further comprise:
presenting, via the display device, a visual representation of the contour;
receiving the user input designating a contour segment; and
determining a closed contour comprising the contour and at least one of the contour segment or an approximation of the contour segment.

8. The system according to claim 1, wherein the operations further comprise:
receiving the user input designating a thickness and a cutting plane;
determining an extrusion of a closed contour normal to the cutting plane and having the designated thickness; and
presenting, via the display device, a visual representation of the extrusion.

9. The system according to claim 8, wherein the operations further comprise:
receiving the user input designating a second, different thickness;
determining the extrusion of the closed contour normal to the cutting plane tapering in thickness across the cutting plane between the designated thickness and the second thickness; and
presenting, via the display device, a visual representation of the extrusion.

10. The system according to claim 1, wherein the operations further comprise:
determining a region partition and a region count M based on a closed contour;
presenting, via the display device, a visual representation of the region partition;
receiving the user input indicating a second, different region count;
determining a second region partition based on the closed contour and the second region count; and
presenting, via the display device, a visual representation of the second region partition;

11. The system according to claim 1, wherein the operations further comprise:
receiving the user input designating a cutting plane;
determining a contour of a portion of the three-dimensional model in the cutting plane, the contour comprising a plurality of segments;
determining the modified three-dimensional model comprising an extrusion of the contour normal to the cutting plane, wherein the determining modified three-dimensional model comprises determining the following elements of the extrusion:
a first face substantially parallel to the cutting plane,
a second face substantially parallel to the cutting plane, and
a plurality of extruded faces extending substantially normal to the cutting plane and associated with respective segments of the plurality of segments;
determining a face of the plurality of faces as a connecting face;
determining data of a plurality of faces based at least in part on the modified three-dimensional model; and
determining the manufacturing data comprising a planar arrangement in which each face of the plurality of faces has substantially no overlap with any other face of the plurality of faces, wherein the manufacturing data comprises the data of the plurality of faces and the data of the plurality of faces comprises:
data of the first face,
data of the second face,
data of the connecting face connected to both the first face and the second face, and
data of the remaining extruded faces other than the connecting face, each remaining extruded face connected to at most one of the first face and the second face.

12. A method, comprising:
displaying a three-dimensional model on a display device, the three-dimensional model having data of a plurality of primitives and adjacency information associating individual ones of those primitives with each other;
receiving user input of a suggested segment contour on the three-dimensional model via a user-operable input device; and
determining a segmentation of the three-dimensional model based at least in part on the user input, the data of the primitives, and the adjacency information.

13. The method according to claim 12, further comprising:
receiving the user input comprising at least one stroke on a surface of the three-dimensional model;
determining a plurality of candidate partitioning curves based at least in part on the stroke and a concavity of the surface in the vicinity of the at least one stroke;
selecting a preferred partitioning curve from the plurality of candidate partitioning curves based at least in part on at least one of: concavities along curves of the plurality of candidate partitioning curves; lengths of the curves; or proximities of the curves to the at least one stroke; and
determining the segmentation comprising a plurality of mesh segments divided along the preferred partitioning curve.

14. The method according to claim 13, further comprising:
receiving second user input designating a first segment of the plurality of mesh segments and a cutting plane;
determining a contour of the first segment with respect to the cutting plane;
determining data of an extrusion of the contour normal to the cutting plane; and
presenting, via the display device, a visual representation of the extrusion and a visual representation of a second, different segment of the plurality of mesh segments.

15. A method, comprising:
receiving data of a three-dimensional model; and
determining data of a planar model based at least in part on:
the data of the three-dimensional model, and
data of a cutting plane.

16. The method according to claim 15, further comprising:
determining a contour of the three-dimensional model in the cutting plane, the contour comprising a plurality of segments;
determining an extrusion of the contour normal to the cutting plane, wherein the extrusion comprises:
a first face substantially parallel to the cutting plane,
a second face substantially parallel to the cutting plane, and
a plurality of extruded faces extending substantially normal to the cutting plane and associated with respective segments of the plurality of segments;
determining a face of the plurality of faces as a connecting face; and
determining data of a plurality of faces based at least in part on the extrusion; and
determining the data of the planar model comprising a planar arrangement in which each face of the plurality of faces has substantially no overlap with any other face of the plurality of faces, wherein the data of the planar model comprises the data of the plurality of faces and the data of the plurality of faces comprises:
data of the first face,
data of the second face,
data of the connecting face connected to both the first face and the second face, and
data of the remaining extruded faces other than the connecting face, each remaining extruded face connected to at most one of the first face and the second face.

17. The method according to claim 15, further comprising:
determining a self-overlap of the planar model; and
in response to determining the self-overlap, modifying the data of the planar model to determine a second planar model that does not exhibit the self-overlap.

18. The method according to claim 15, further comprising:
receiving data of a second three-dimensional model;
receiving data of a spatial relationship between the three-dimensional model and the second three-dimensional model; and
determining data of a second planar model based at least in part on:
the data of the second three-dimensional model, and
data of a second cutting plane.

19. The method according to claim 18, wherein:
the determining the data of the planar model comprises determining at least one joint location in the planar model; and
the determining the data of the second planar model comprises determining at least one joint location in the second planar model.

20. The method according to claim 18, further comprising receiving the data of the spatial relationship via a widget presented in a user interface, wherein the spatial relationship comprises at least one of a rotational relationship about an axis, a rotational relationship about a point, or a translational relationship along an axis.
